(19) United States
(12) Patent Application Publication
(10) Pub. No.: US 2014/0078550 A1
(43) Pub. Date: Mar. 20, 2014

(54) PRINT CONTROL APPARATUS, COMPUTER-READABLE RECORDING MEDIUM, AND PRINTING SYSTEM

(71) Applicant: Konica Minolta, Inc., Chiyoda-ku (JP)

(72) Inventors: Mitsutaka MORITA, Nagoya-shi (JP); Kaoru FUKUOKA, Toyokawa-shi (JP); Tomokazu KATO, Toyokawa-shi (JP); Hiroki UEDA, Toyohashi-shi (JP)

(73) Assignee: Konica Minolta, Inc., Chiyoda-ku (JP)

(21) Appl. No.: 14/029,346

(22) Filed: Sep. 17, 2013

(30) Foreign Application Priority Data
Sep. 18, 2012 (JP) 2012-204259

(51) Int. Cl. G06F 3/12

(52) U.S. Cl. CPC G06F 3/1256
USPC 358/1.15

(57) ABSTRACT

A print control apparatus includes a receiving unit configured to receive a first e-mail that includes a print preview instruction from an external terminal, an analysis unit configured to analyze the first e-mail and detect the print preview instruction from the first e-mail, a generation unit configured to generate a preview image on the basis of the print preview instruction, and a sending unit configured to attach the preview image to a second e-mail and send the second e-mail toward the external terminal.

This application is based on Japanese Patent Application No. 2012-204259 and filed on Sep. 18, 2012, the contents of which are hereby incorporated by reference.

### BACKGROUND OF THE INVENTION

1. Technical Field

The present invention relates to a printing technique and in particular to a print preview technique.

2. Related Art

Printing apparatuses such as MFPs in recent years have a function of printing out attached files of electronic mails (e-mails) (also referred to as the“Mail-to-Print” function). Specifically, when an e-mail with a target print file attached is set to the e-mail address of such a printing apparatus, the printing apparatus can print out the attached file (see Japanese Patent Application Laid-Open No. 2001-306272).

This function allows an external terminal (e.g., a personal computer or a mobile terminal) in which a printer driver is not installed to instruct an MFP to print out a file to be printed.

The “Mail-to-Print” function as described above, however, cannot go beyond giving a printout instruction using ordinary mail software (mailer), and a print preview image cannot be checked on the external terminal side.

Japanese Patent Application Laid-Open No. 2003-099238 discloses a technique for allowing a user to check a printout result before forming an image when a print instruction is given from a personal computer to a printer via application software and a printer driver that are installed in the personal computer. To be specific, the printer generates image data for printing on the basis of command data or the like that has been sent from the printer driver and sends an e-mail with the image data for printing attached to an e-mail address specified by the print instruction. A user who has received the e-mail can browse the image data attached to the e-mail, using an image viewer or the like.

The technique of Japanese Patent Application Laid-Open No. 2003-099238 is, however, based on the assumption that a print instruction is given from an apparatus (personal computer) in which the printer driver is installed. Thus, external terminals (e.g., mobile terminals) in which a printer driver is not installed cannot provide print instructions, and accordingly preview images of files to be printed cannot be browsed with the external terminals.

### SUMMARY OF THE INVENTION

It is an object of the present invention to provide a technique that enables a user to easily browse a print preview image of a file to be printed on an external terminal in which a printer driver is not installed.

According to a first aspect of the present invention, a print control apparatus includes a receiving unit configured to receive a first e-mail that includes a print preview instruction from an external terminal, an analysis unit configured to analyze the first e-mail and detect the print preview instruction from the first e-mail, a generation unit configured to generate a preview image on the basis of the print preview instruction, and a sending unit configured to attach the preview image to a second e-mail and send the second e-mail toward the external terminal.

According to a second aspect of the present invention, a non-transitory computer-readable recording medium storing a program for causing a computer serving as a print control apparatus to execute a) receiving a first e-mail that includes a print preview instruction from an external terminal, b) analyzing the first e-mail and detecting the print preview instruction from the first e-mail, c) generating a preview image on the basis of the print preview instruction, and d) attaching the preview image to a second e-mail and sending the second e-mail toward the external terminal.

According to a third aspect of the present invention, a printing system includes a printout apparatus that includes a print control apparatus, and an external terminal. The printout apparatus includes a receiving unit configured to receive a first e-mail that includes a print preview instruction from the external terminal, an analysis unit configured to analyze the first e-mail and detect the print preview instruction from the first e-mail, a generation unit configured to generate a preview image on the basis of the print preview instruction, and a sending unit configured to attach the preview image to a second e-mail and send the second e-mail toward the external terminal.

According to a fourth aspect of the present invention, a printing system includes a printout apparatus, a print control apparatus, and an external terminal. The print control apparatus includes a receiving unit configured to receive a first e-mail that includes a print preview instruction from the external terminal, an analysis unit configured to analyze the first e-mail and detect the print preview instruction from the first e-mail, a generation unit configured to generate a preview image on the basis of the print preview instruction, and a sending unit configured to attach the preview image to a second e-mail and send the second e-mail toward the external terminal.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a printing system according to a first embodiment.

FIG. 2 is a functional block diagram illustrating a schematic configuration of an MFP.

FIG. 3 illustrates operations performed in a printing system.

FIG. 4 is a flowchart of operations performed by the MFP.

FIG. 5 shows a first e-mail.

FIG. 6 shows a second e-mail.

FIG. 7 shows a third e-mail.

FIG. 8 illustrates a state in which a printout image is stored in association with a unique number.

FIG. 9 illustrates a state in which a preview image is displayed in a mobile terminal.

FIG. 10 shows a variation on the second e-mail.

FIG. 11 shows a variation on the third e-mail.

FIG. 12 shows a first e-mail according to a second embodiment.

FIG. 13 is a flowchart of operations performed by the MFP according to the second embodiment.

FIG. 14 illustrates five different composite settings serving as alternatives.

FIG. 15 shows a preview image according to an alternative.

FIG. 16 shows a preview image according to an alternative.

FIG. 17 shows a preview image according to an alternative.

FIG. 18 shows a preview image according to an alternative.

FIG. 19 shows a preview image according to an alternative.

FIG. 20 shows a composite image of the five preview images.

FIG. 21 illustrates operations performed in the system according to the second embodiment.

FIG. 22 shows a second e-mail according to the second embodiment.

FIG. 23 shows a third e-mail according to the second embodiment.

FIG. 24 is a flowchart showing part of the operations performed by the MFP according to the second embodiment.

FIG. 25 illustrates operations performed in the system according to a third embodiment.

FIG. 26 shows a second e-mail according to the third embodiment.

FIG. 27 shows a third e-mail according to the third embodiment.

FIG. 28 is a flowchart showing part of operations performed by the

MFP according to the third embodiment.

FIG. 29 illustrates operations performed in the system according to a fourth embodiment.

FIG. 30 shows a second e-mail according to the fourth embodiment.

FIG. 31 shows a third e-mail according to the fourth embodiment.

FIG. 32 is a flowchart showing part of operations performed by the MFP according to the fourth embodiment.

FIG. 33 is a flowchart showing part of the operations performed by the MFP according to a variation.

FIG. 34 illustrates alternatives to print settings including prohibited combination settings.

FIG. 35 shows a modified example of a system configuration.

### DETAILED DESCRIPTION OF THE PREFERRED EMBODIMENTS

Hereinafter, embodiments of the present invention will be described with reference to the drawings.

### 1. First Embodiment

### 1-1. Overall Configuration

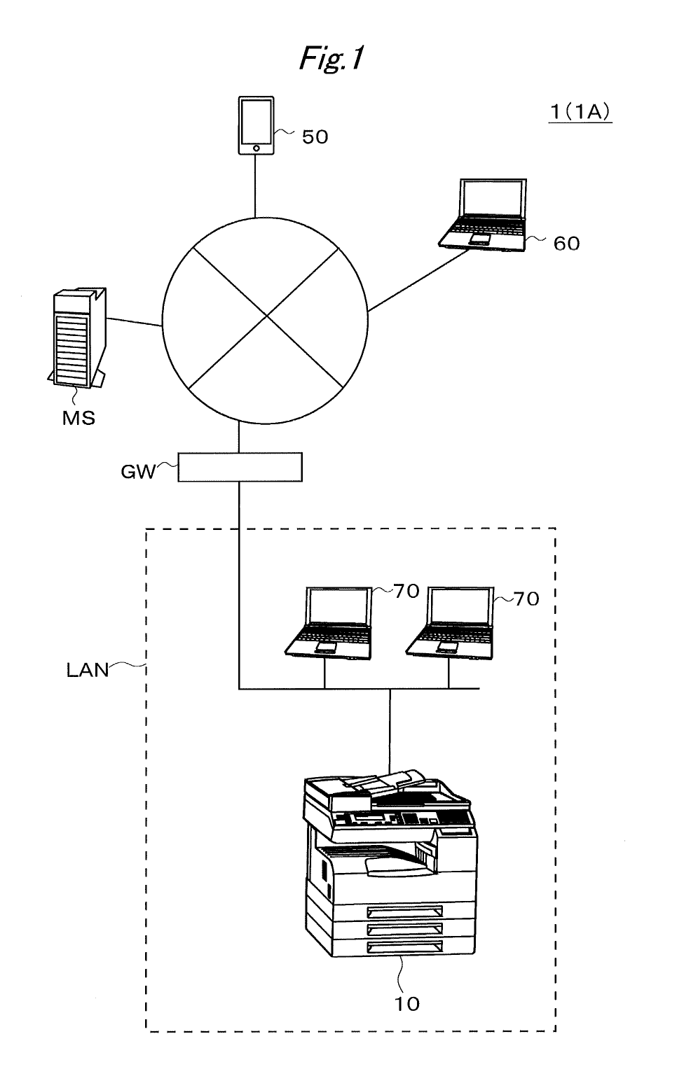

FIG. 1 illustrates a printing system 1 (specifically, 1A) according to a first embodiment. As illustrated in FIG. 1, the printing system 1A includes a Multi-Functional Peripheral (MFP) 10 and a mobile terminal 50. The printing system 1A also includes, for example, personal computers 60 and 70.

The MFP 10 functions as a print control apparatus and also functions as a printout apparatus.

The mobile terminal 50 is an external terminal apparatus outside the MFP 10 and is also referred to as an “external terminal.” Similarly, the personal computers 60 and 70 are also referred to as “external terminals.”

The constituent elements 10, 50, 60, and 70 of this system 1 are each connected to a network NW. The network NW is configured by, for example, a local area network (LAN) and the Internet. The form of connection to the network NW may be either wired or wireless. For example, the MFP 10 and the personal computers 60 and 70 are each connected via a cable to the network NW, and the mobile terminal 50 is wirelessly connected to the network NW.

The constituent elements 10, 50, 60, and 70 of this system 1 are each capable of accessing a mail server MS via the network NW and exchanging e-mails among them via the mail server MS.

In the present example, the MFP 10 is connected to the LAN (e.g., an intra-company network). Similarly, the personal computers 70 are also connected to the LAN. On the other hand, the mobile terminal 50 is connected to a network (external network) different from the LAN. In other words, the mobile terminal 50 belongs to the network different from the network to which the MFP 10 belongs. Between the MFP 10 and the mobile terminal 50 exists a gateway server GW (or a router) that restricts direct access of the mobile terminal 50 to the apparatuses (e.g., MFP 10) in the LAN. For example, the MFP 10 is assigned only a private IP address and is not assigned a global IP address (static address). The mobile terminal 50 thus cannot communicate with the MFP 10, using the IP address (e.g., communication using the Transmission Control Protocol/Internet Protocol (TCP/IP)), and specifically, cannot access or be accessed by the MFP 10, using the global IP address.

As described above, it is not easy for the mobile terminal 50 to access information in the MFP 10.

In contrast, in the present embodiment, the mobile terminal 50 exchanges various types of data (in particular, preview images PV) with the MFP 10, using e-mails as will be described later. The mobile terminal 50 is thus capable of acquiring various types of information relatively easily from the MFP 10.

### 1-2. Configurations of MFP 10 and Mobile Terminal 50

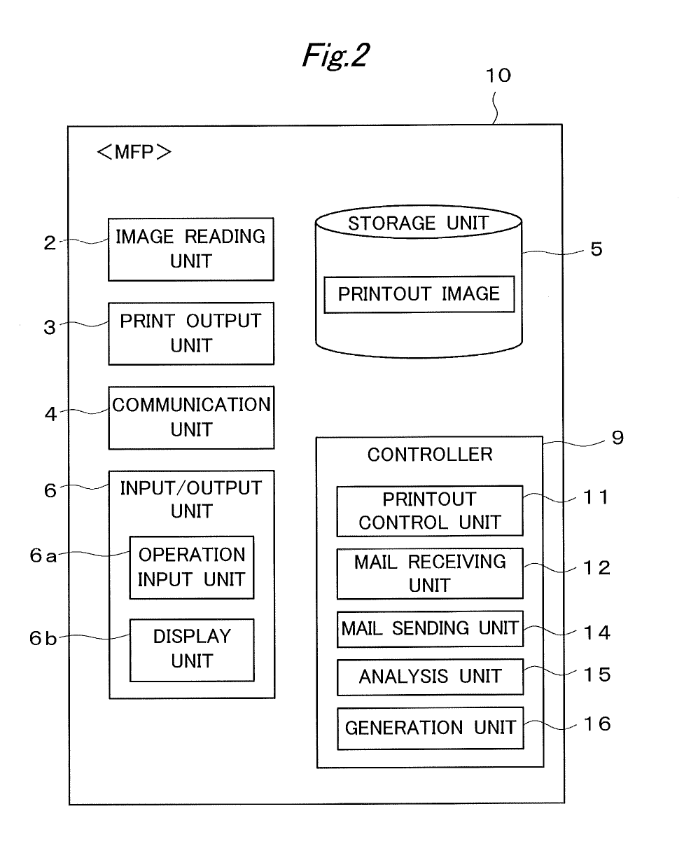

FIG. 2 is a functional block diagram illustrating a schematic configuration of the MFP 10.

The MFP 10 is an apparatus (also referred to as the “Multi-Functional Peripheral”) having functions such as a scan function, a copy function, a facsimile function, and a box storage function. Specifically, the MFP 10 includes, for example, an image reading unit 2, a print output unit 3, a communication unit 4, a storage unit 5, an input/output unit 6, and a controller 9 as illustrated in the functional block diagram of FIG. 2. The MFP 10 implements various functions by operating the above units in combination.

The image reading unit 2 is a processing unit configured to optically read (i.e., scan) an original document placed at a predetermined position on the MFP 10 and generate image data for this document (also referred to as an “original image” or a “scanned image”). The image reading unit 2 is also referred to as a “scan unit”.

The print output unit 3 is an output unit configured to print out an image on various types of media such as paper on the basis of data regarding an object to be printed.

The communication unit 4 is a processing unit capable of facsimile communication via a public network or the like. The communication unit 4 is also capable of network communication via the network NW. In the network communication, various types of protocols such as the Transmission Control Protocol/Internet Protocol (TCP/IP), the Simple Mail Transfer Protocol (SMTP), and the Post Office Protocol (POP) are used. Using the network communication (specifically, communication using TCP/IP or the like) allows the MFP 10 to exchange various types of data mainly with a desired destination within the LAN. Using the network communication (specifically, communication using SMTP, POP, or the like) also allows the MFP 10 to exchange e-mails ML with a desired destination within and outside the LAN via the mail server MS.

The storage unit 5 is constituted by a storage device such as a hard disk drive (HDD). The storage unit 5 has stored therein images for printing out (printout images) PM and the like. In the storage unit 5, the printout images PM or the like are each stored in association with a unique identification number (unique number).

The input/output unit 6 includes an operation input unit 6a configured to receive input to the MFP 10, and a display unit 6b configured to display and output various types of information.

The controller 9 is a control device that is built into the MFP 10 and performs overall control of the MFP 10. The controller 9 is configured as a computer system that includes, for example, a CPU and various types of semiconductor memories (RAM and ROM). The controller 9 implements various types of processing units by causing the CPU to execute a predetermined software program (hereinafter, also simply referred to as a “program”) PG1 stored in the ROM (e.g., EEPROM). The program PG1 may be recorded in a portable recording medium such as a USB memory (in other words, various types of computer-readable non-transitory recording media) and installed into the MFP 10 via the recording medium. Alternatively, the program PG1 may be downloaded via the network NW or the like and installed into the MFP 10.

Specifically, as illustrated in FIG. 2, the controller 9 implements various types of processing units including a printout control unit 11, a mail receiving unit 12, a mail sending unit 14, an analysis unit 15, and a generation unit 16.

The printout control unit 11 is a processing unit configured to control printout processing in cooperation with the print output unit 3 or the like.

The mail receiving unit 12 and the mail sending unit 14 are processing units configured to control the operations of communicating by e-mail with other apparatuses in cooperation with the communication unit 4 or the like.

The mail receiving unit 12 is a processing unit configured to receive, via the mail server MS (see FIG. 1), e-mails that have been sent from other devices (e.g., the mobile terminal 50) by operation of transmission source users and are temporarily stored in the mail server MS (in short, e-mails from other users and apparatuses). For example, the mail receiving unit 12 receives a print preview instruction VD from the mobile terminal 50 via an e-mail ML1 (described later).

The mail sending unit 14 is a processing unit configured to send e-mails to other users or apparatuses (e.g., the mobile terminal 50). Such e-mails are sent to transmission destination users (and transmission destination apparatuses) via the mail server MS. For example, the mail sending unit 14 attaches a preview image PV of a file to be printed to an e-mail ML2 (described later) and sends the e-mail ML2 to the mobile terminal 50.

The analysis unit 15 is a processing unit configured to analyze received e-mails ML. The analysis unit 15 determines, for example, whether or not the print preview instruction VD is written in the e-mail ML1 (the presence or absence of the print preview instruction VD) and detects the print preview instruction VD from the e-mail ML1. The analysis unit 15 also detects the content of the print preview instruction VD written in the e-mail ML1. More specifically, the analysis unit 15 also detects print setting information written in the e-mail ML1.

The generation unit 16 is a processing unit configured to generate the preview image PV on the basis of the print preview instruction VD. The generated preview image PV is attached to the e-mail ML1 and sent to the mobile terminal 50. The generation unit 16 also generates a printout image PM1 when generating the preview image PV1.

The mobile terminal 50 (see FIG. 1) is an apparatus capable of network communication with other apparatuses. Examples of the mobile terminal 50 include portable information input/output terminal apparatuses such as smartphones and tablet terminals.

Mail client software (mailer) PG5 is installed in the mobile terminal 50, and the mobile terminal 50 is capable of exchanging e-mails with other apparatuses (users) via the mail server MS.

### 1-3. Operations

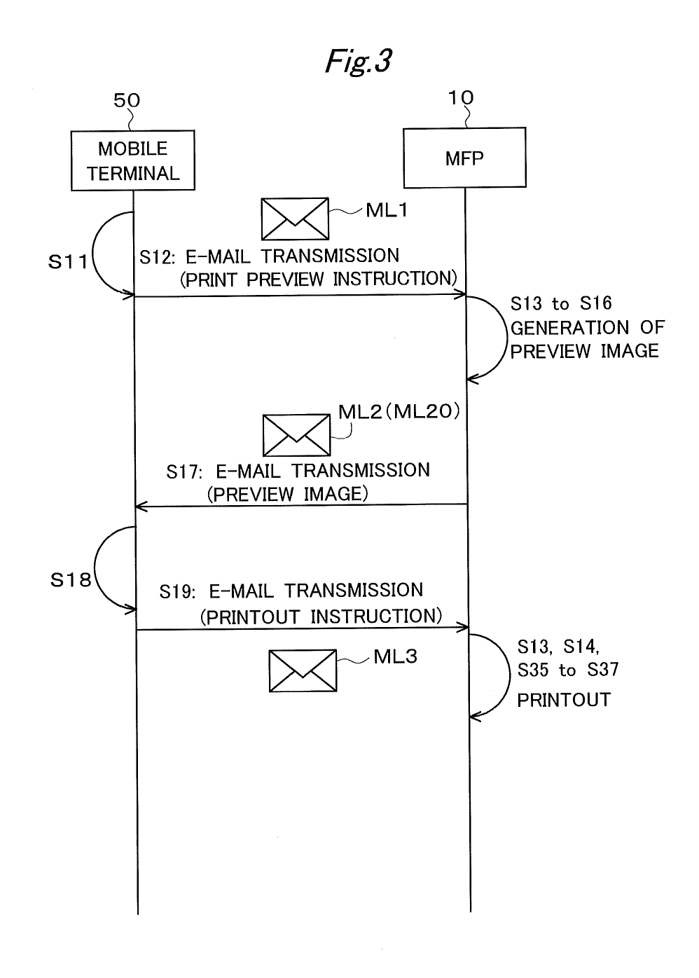

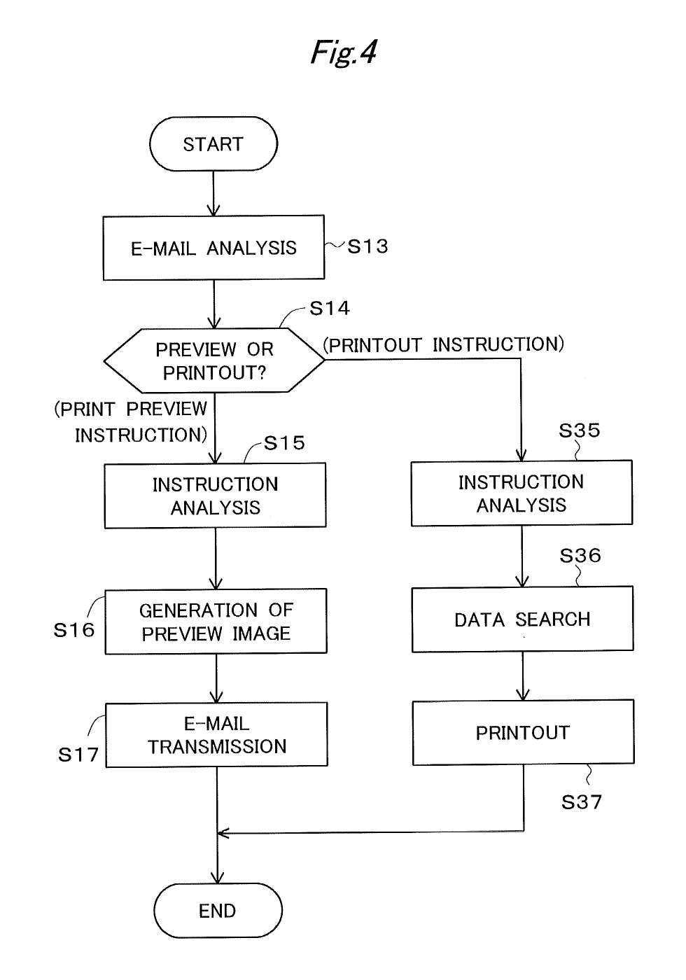

FIG. 3 illustrates operations performed in this system 1. FIG. 4 is a flowchart of operations performed by the MFP 10. Hereinafter, the operations performed in this system 1 will be described with reference to FIGS. 3 and 4.

As illustrated in FIG. 3, first, the mobile terminal 50 sends an e-mail ML1 to the MFP 10 in response to an operation by a user UA (steps S11 and S12). The e-mail ML1 is an e-mail in which a print preview instruction VD is written. Next, the MFP 10 generates a preview image PV on the basis of the print preview instruction VD and sends an e-mail ML2 (ML20) with the preview image PV attached to the user UA (the mobile terminal 50) (steps S13 to S17 in FIG. 4). The user UA receives the e-mail ML2 on the mobile terminal 50 and confirms the attached preview image PV (step S18). If it is determined that printing is to be performed in the settings that have been confirmed using the preview image PV, the user UA sends an e-mail ML3 to the MFP 10, using the mobile terminal 50 (step S19). The e-mail ML3 is an e-mail in which a printout instruction PD is written. The MFP 10 then performs printout processing in accordance with the printout instruction PD (steps S13, S14, and S35 to S37 in FIG. 4).

Hereinafter, the above operations will be described in further detail.

First, the print preview instruction VD is sent by the e-mail ML1 from the mobile terminal 50 to the MFP 10 as in shown steps S11 and S12 (FIG. 3).

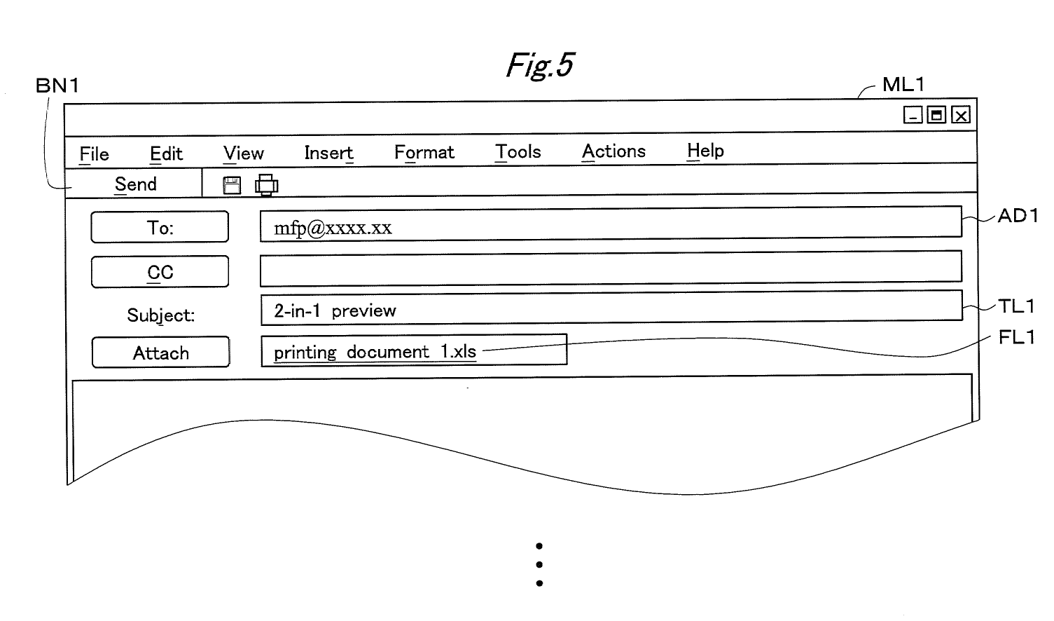

FIG. 5 shows an example of such an e-mail ML1. The e-mail address “mfp@****.**” of the MFP 10 is written in an address field AD1 of the e-mail ML1. In accordance with this description, the e-mail ML1 is sent from the mobile terminal 50 to the e-mail address of the MFP 10.

A data file FL1 to be processed is attached to the e-mail ML1 through an operation of the user UA. In FIG. 5, the e-mail ML1 has the data file FL1 with a filename “printing document 1.xls” attached.

Also, the words “2-in-1, preview” are written in a subject field TL1 of the e-mail ML1 through an operation of the user UA. In particular, the word “preview” (keyword) included in the subject field TL1 indicates that this e-mail ML1 provides the print preview instruction VD. The word “2-in-1” is a description (keyword) that indicates print setting information.

In this way, the user UA specifies the MFP 10 as a destination of the e-mail ML1 and attaches the data file FL1 to be processed to the e-mail ML1. The user UA also writes the word “preview” indicating the print preview instruction VD and the designation content “2-in-1” indicating the print setting information in the subject field TL1 of the e-mail ML1 (step S11).

Then, the user UA presses a send button BN1 (FIG. 5) on the mailer PG5. In response to this pressing of the button, the mailer PG5 on the mobile terminal 50 sends the e-mail ML1 to the e-mail address of the MFP 10 via the mail server MS (step S12).

Thereafter, when the mail receiving unit 12 of the MFP 10 receives the e-mail ML1 via the mail server MS, the analysis unit 15 of the MFP 10 analyzes the e-mail ML1 and detects the presence or absence of the print preview instruction VD in the e-mail ML1 (step S13).

Specifically, if the e-mail ML1 is addressed to the MFP 10 and contains the word “preview” in the subject line, the MFP 10 determines the e-mail ML1 as an e-mail for providing an instruction that instructs the MFP 10 to display a print preview (print preview instruction VD). In other words, the analysis unit 15 analyzes the content written in the subject line of the e-mail ML1 and detects the print preview instruction VD from the e-mail ML1 under the condition that the subject line of the e-mail ML1 contains a first specific character string “preview.” The processing then proceeds from step S14 to step S15. Note that an e-mail ML (ML3) that contains a second specific character string “unique number” in the subject line is determined as an e-mail for providing the printout instruction PD, which will be described later. In this case, the processing proceeds from step S14 to step S35. In other words, the processing branches in step S14 depending to the type of the received e-mail, either ML1 or ML3.

In step S15, the MFP 10 (the analysis unit 15) analyzes in detail the print preview instruction VD included in the e-mail ML1.

To be more specific, the MFP 10 (analysis unit 15) first recognizes the attached file FL1 in the e-mail ML1 as data to be printed in accordance with the print preview instruction VD.

The MFP 10 (the analysis unit 15) also analyzes the print setting information written in the subject field TL1 of the e-mail ML1. For example, the character string (keyword) “2-in-1” contained in the subject field TL1 represents a print setting “N-in-1” (N=2) indicating that N pages are laid out in a single sheet of paper. Upon detecting the description in the subject field TL1, the analysis unit 15 of the MFP 10 determines that the print setting “N-in-1 (2-in-1)” is specified.

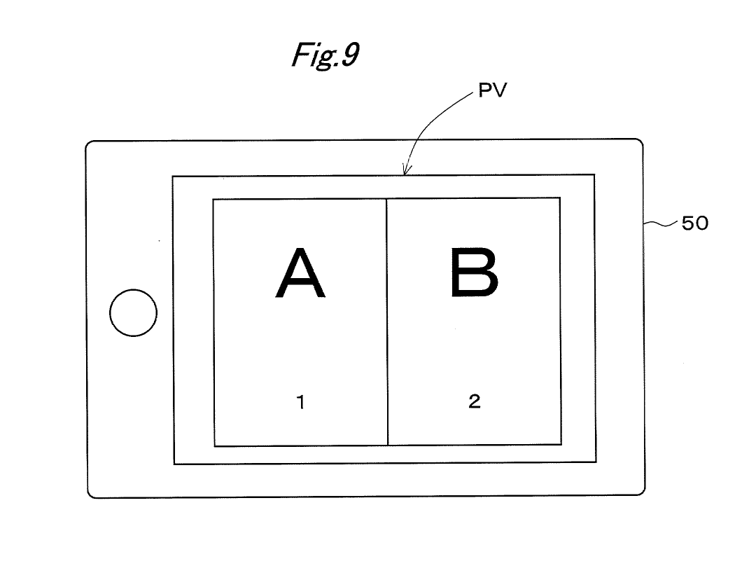

Then, in step S16, the generation unit 16 of the MFP 10 generates a print preview image PV (also simply referred to as a “preview image”) of the data file FL1 to be printed, in accordance with the print preview instruction VD. The preview image PV is generated on the basis of the print setting information in the subject field TL1. For example, when “2-in-1” is specified in the print setting information, the preview image PV reflecting this setting “2-in-1” is generated (see FIG. 9).

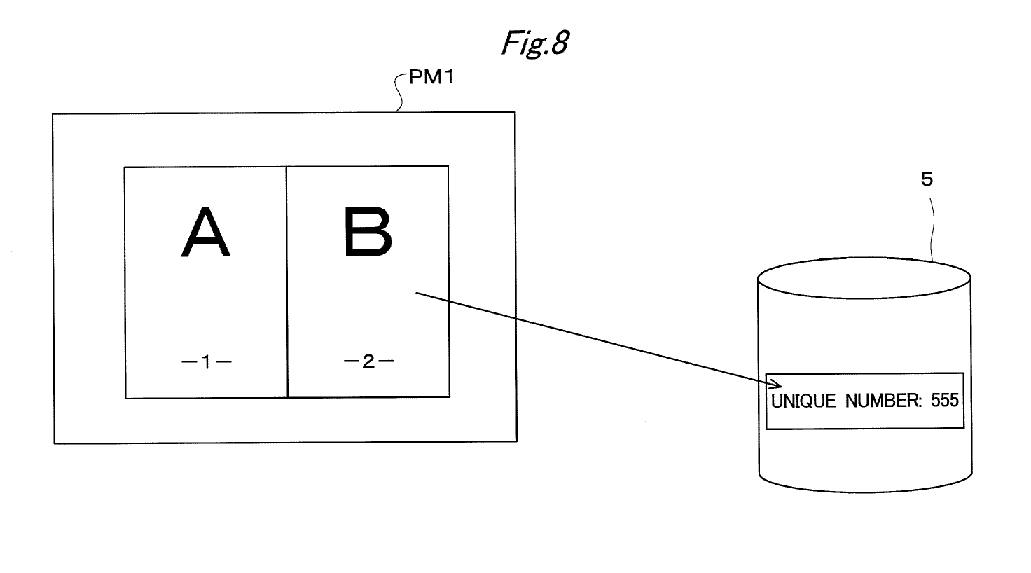

In step S16, the generation unit 16 also generates a printout image PM1 of the data file FL1 (in other words, the printout image PM1 corresponding to the preview image PV1) when generating the preview image PV1, and stores the generated printout image PM1 into the storage unit 5. The printout image PM1 is stored in the storage unit 5 in association with a unique identification number (unique number) (e.g., “555”) (see FIG. 8). As will be described later, providing the printout instruction PD using such a unique number (identifier) makes it easy to acquire the printout image PM associated with the unique number from the storage unit 5.

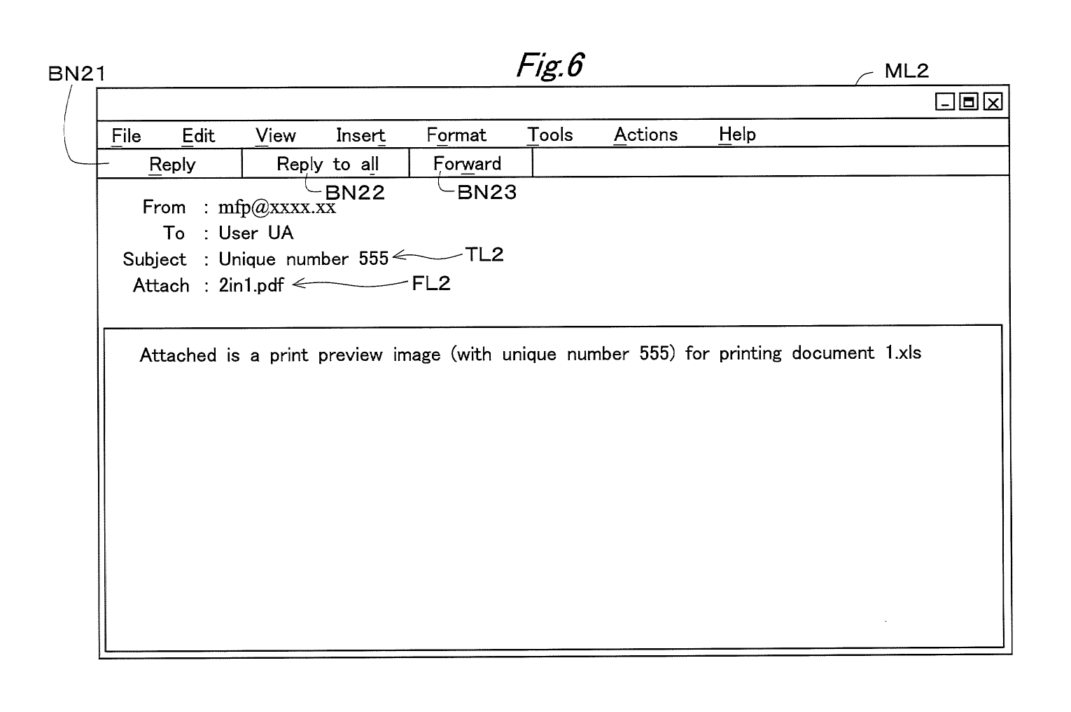

Next, in step S17, the mail sending unit 14 of the MFP 10 automatically generates an e-mail ML2 with the preview image PV attached (see FIG. 6). As shown in FIG. 6, the preview image PV (attached file FL2) with a filename “2-in-1.pdf' is attached to the e-mail ML2. The destination of the e-mail ML2 is set to be the transmission source of the e-mail ML1 (here, the e-mail address of the user UA). Thus, the e-mail ML2 can also be said to be a reply to the e-mail ML1. The mail sending unit 14 also writes a unique number (identifier) for identifying the printout image corresponding to the print preview instruction VD in the e-mail ML2. For example, in FIG. 6, the unique number “555” is written in a subject field TL2 of the e-mail ML2. In addition, the message “Attached is the print preview image (with unique number 555) of printing document 1.xls” is written in the body field of the e-mail ML2. That is, the unique number “555” is also written in the body field. As will be described later, providing a printout instruction using this unique number makes it easy to print out the preview image corresponding to the print preview instruction.

Then, the mail sending unit 14 sends the e-mail ML2 to the mobile terminal 50 (step S17).

Meanwhile, the mobile terminal 50 receives the e-mail ML2 addressed to the user UA from the MFP 10. The preview image PV (attached file FL2) attached to the e-mail ML2 is browsed using predetermined browsing software through an operation of the user UA (step S18 (FIG. 3)). FIG. 9 illustrates a state in which the preview image PV (attached file FL2) is displayed on the mobile terminal 50 (specifically, the display unit of the mobile terminal 50).

Then, if the user UA determines to print out the content of the preview image PV, the mobile terminal 50 sends an e-mail ML3 to the MFP 10 in response to an operation of the user UA (step S19). The e-mail ML3 is an e-mail in which the printout instruction PD is written.

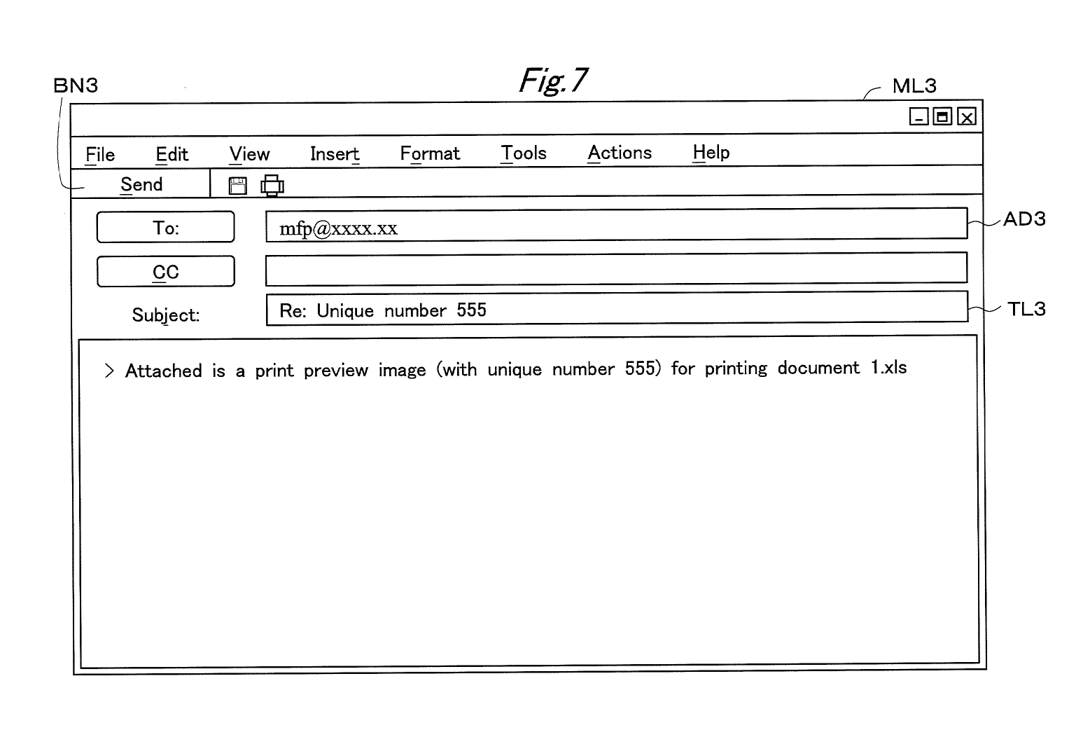

To be more specific, the user UA generates the e-mail ML3 containing a print instruction given to the MFP 10 as shown in FIG. 7. For example, the user UA first presses a reply button BN21 in the window for browsing the e-mail ML2 (FIG. 6) so as to generate the e-mail ML3 for reply (and for providing an additional instruction) as shown in FIG. 7. The e-mail address “mfp@****.**” of the MFP 10 is written in an address field AD3 of the e-mail ML3. Also, the words “Re: unique number 555” is written in a subject field TL3 of the e-mail ML3. The description in the subject field TL3 is constituted by a character string generated by adding “Re:” (a character string indicating a reply) to the subject line “unique number 555” of the e-mail ML2 (the return e-mail from the MFP 10). Thereafter, when the send button BN3 is pressed by the user UA, the e-mail ML3 is sent to the MFP 10.

Although in the present example, the e-mail ML3 is generated in response to the pressing of the reply button BN21, the present invention is not limited thereto. For example, the e-mail ML3 may be generated in response to the pressing of a forward button BN23. In this case, the e-mail address of the MFP 10 may be specified as a forwarding address through a user operation. The e-mail ML3 for reply may be generated in this way.

Upon receiving the e-mail ML3 thereafter, the MFP 10 performs printout processing in accordance with the printout instruction PD contained in the e-mail ML3.

Specifically, upon receiving the e-mail ML3, the MFP 10 performs the operations illustrated in FIG. 4. More specifically, in the mail analysis operation (step S13), if the e-mail ML (ML3) is addressed to the MFP 10 and contains a character string such as “unique number” and/or “Re” in the subject line, the MFP 10 determines that the e-mail ML (ML3) is an e-mail for providing the printout instruction PD. To be more specific, the analysis unit 15 analyzes the content written in the subject line of the e-mail ML, and if the subject line of the e-mail ML contains the words corresponding to the second specific character string (e.g., “unique number” and/or “Re”), the analysis unit 15 detects the printout instruction PD from the e-mail ML (ML3). The processing then proceeds from step S14 to step S35. If the subject line of the e-mail ML contains both of the first specific character string (e.g., “preview”) and the second specific character string (e.g., “unique number” and/or “Re”), the printout instruction PD may be preferentially detected.

In step S35, the analysis unit 15 analyzes in detail the printout instruction PD written in the e-mail ML3. Specifically, the analysis unit 15 acquires the unique number itself (“555”) that is written following the words “unique number” as a detailed content of the instruction.

Then, an operation of searching for data of the printout image PM is performed in step S36. Specifically, the analysis unit 15 specifies the printout image PM1 corresponding to the preview image PV1 from among a plurality of printout images PMi stored in the storage unit 5, using the unique number “555” written in the e-mail ML3.

In step S37, the printout control unit 11 of the MFP 10 prints out the printout image PM1 in accordance with the printout instruction PD. As a result, the target file FL1 specified in the print preview instruction VD in the e-mail ML1 is printed out.

Upon completion of the printout of the printout image PM1 in step S37, the printout control unit 11 deletes the printout image PM1 from the storage unit 5. This makes it possible to improve security and to make effective use of the storage area of the storage unit 5.

As described above, upon receiving the print preview instruction VD from the mobile terminal 50 by the e-mail ML1, the MFP 10 generates the preview image PV1 in accordance with the print preview instruction VD, attaches the preview image PV1 to the e-mail ML2, and sends the e-mail ML2 to the mobile terminal 50. Accordingly, the preview image of a file to be printed can be easily browsed even on the mobile terminal 50 in which a printer drive is not installed.

In addition, data (in particular, preview image data) is exchanged through e-mails ML between the mobile terminal 50 and the MFP 10, without requiring data communication using IP addresses. Accordingly, the preview file of a file to be printed can be easily browsed even on the mobile terminal 50 that belongs to a network (external network) different from the network (LAN) to which the MFP 10 belongs.

### 1-4. Variations

While the above embodiment describes a mode in which the specific character string “preview” indicating the print preview instruction

VD is contained in the “subject line” of the e-mail ML1, the present invention is not limited to this. For example, the specific character string “preview” may be contained in the “body” of the e-mail ML1, and the print preview instruction VD may be detected from the body of the e-mail ML1.

While the above embodiment describes a mode in which the print setting information is contained in the “subject line” of the e-mail ML1, the present invention is not limited to this. For example, the print setting information may be contained in the “body” of the e-mail ML1, and the print setting information may be detected from the body of the e-mail ML1.

While the above-described embodiment describes a mode in which a printout image is specified (identified) by the unique number (identifier) contained in the “subject line” of the e-mail ML3, the present invention is not limited to this.

For example, a printout image may be specified (identified) by the unique number (identifier) contained in the “body” of the e-mail ML3 (see FIG. 7).

To be more specific, the e-mail ML2 (see FIG. 6) from the MFP 10 has the character string “unique number 555” written in the body. The e-mail ML3 is generated in response to, for example, the pressing of the reply button BN21 in the window displaying the e-mail ML2 and is then sent from the mobile terminal 50 to the MFP 10. The e-mail ML3 quotes the character string containing “unique number 555” in the e-mail ML2 as-is in the body (see FIG. 7). The MFP 10 thus may detect the specific words “unique number” and the unique number itself (“555”) following the specific words in the body of the e-mail ML3 and specify (identify) a printout image on the basis of the detected unique number (“555”).

While in the above embodiment, the character string “unique number” and the unique number “555” itself following the character string are written not only in the subject lines of the e-mails ML2 and ML3 but also in the bodies of the e-mails ML2 and ML3, the present invention is not limited to this. For example, the character string “unique number” and the unique number “555” itself following the character string may be written in only the subject lines of the e-mails ML2 and ML3. In this case, it is sufficient to specify (identify) a printout image by the unique number (identifier) contained in the “subject line” of the e-mail ML3. Conversely, the character string “unique number” and the unique number “555” itself following the character string may be written in only the bodies of the e-mails ML2 and ML3. In this case, it is sufficient to specify (identify) a printout image by the unique number (identifier) contained in the “body” of the e-mail ML3.

In the above embodiment and the like, if the specific character string “unique number” is contained in the subject line or body of the e-mail ML3 addressed to the MFP 10, it is determined that the printout instruction PD is provided. The present invention is, however, not limited to this. For example, it may be determined that the printout instruction PD is provided if the e-mail ML3 (sent via the e-mail ML2) contains a character string indicating that the e-mail ML3 is an e-mail related to the e-mail ML1 (containing the print preview instruction VD).

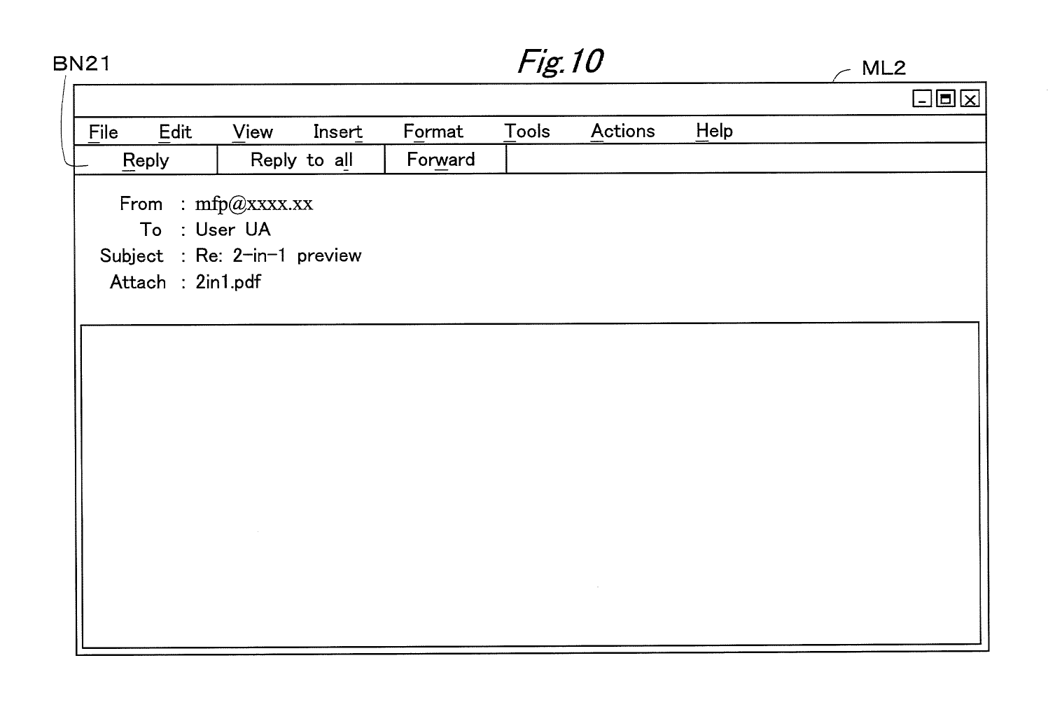

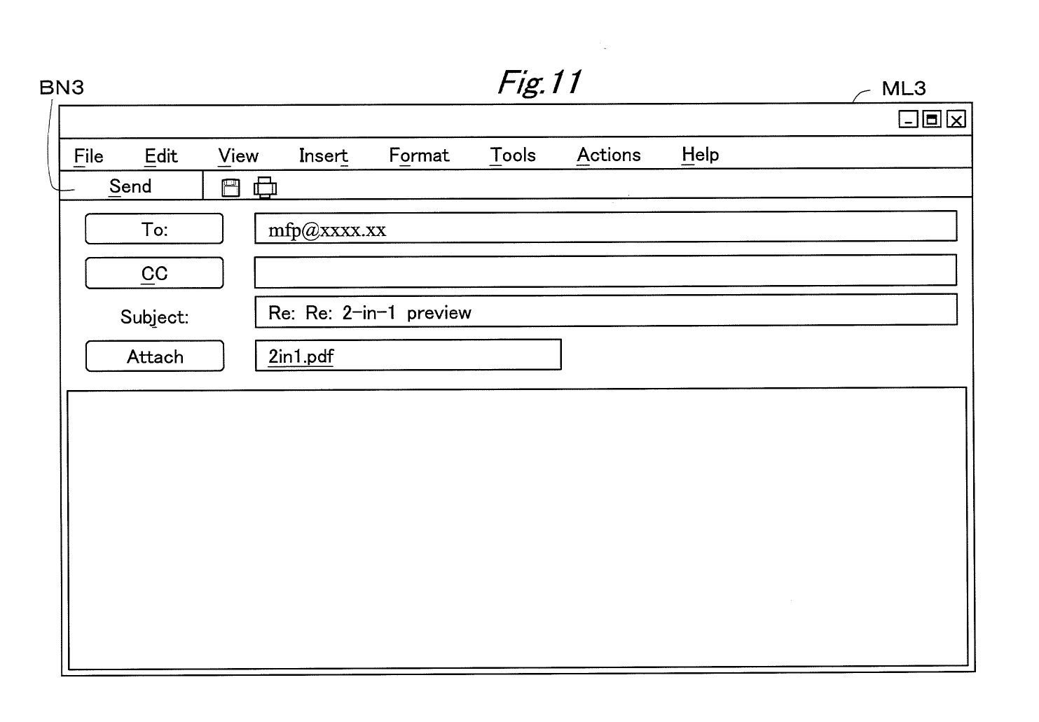

FIGS. 10 and 11 illustrate e-mails ML2 and ML3, respectively, according to such a variation.

The subject line of the e-mail ML2 in FIG. 10 contains a character string (specifically, “Re: 2-in-1, preview”) indicating that the e-mail ML2 is a return e-mail to the e-mail ML1 (containing the print preview instruction VD).

The subject line of the e-mail ML3 in FIG. 11 contains a character string (specifically, “Re: Re: 2-in-1, preview”) indicating that the e-mail ML3 is a return e-mail to the e-mail ML2. This character string indicates that the e-mail ML3 is an e-mail related to the print preview instruction VD. Additionally, the preview image PV1 is also attached to this e-mail ML3. For example, the preview image PV1 is attached to the e-mail ML3 by the user UA performing an operation of attaching the preview image PV1 attached to the e-mail ML2 to the e-mail ML3 (step S18). To be more specific, it is sufficient for the user UA to perform, for example, an operation of dragging and dropping an icon representing the attached file (or an area where the name of the attached filename is displayed) in the e-mail ML2 onto the e-mail ML3. Thereafter, the e-mail ML3 is sent from the mobile terminal 50 to the MFP 10 (step S19).

Upon receiving the e-mail ML3 as shown in FIG. 11, the MFP 10 analyzes the e-mail ML3 (step S13 in FIG. 4).

If it is determined that the e-mail ML3 contains the character string “Re: Re: 2-in-1, preview” indicating that the e-mail ML3 is an e-mail related to the print preview instruction VD, the MFP 10 determines that the e-mail ML3 provides the printout instruction PD. The processing then proceeds from step S14 to step S35.

Then, the operation of analyzing the printout instruction PD (step S35), the operation of specifying the printout image PM specified in the printout instruction PD (step S36), and the printout operation (step S37) are performed.

To be more specific, the analysis unit 15 of the MFP 10 extracts the preview image PV1 from the received e-mail ML3 and determines that the printout instruction PD to print out the printout image PM1 corresponding to the preview image PV1 is provided (step S35).

The analysis unit 15 then specifies the printout image PM1 corresponding to the preview image PV1, using the preview image PV1 attached to the e-mail ML3. Specifically, the analysis unit 15 specifies the printout image PM1 corresponding to the preview image PV1 from among a plurality of printout images PMi stored in the storage unit 5, using a pattern matching technique or the like (step S36). To be more specific, the degree of similarity between each of the printout images PMi and the preview image PV1 may be determined, and a printout image PM whose degree of similarly is the highest among the printout images PMi and is higher than or equal to a predetermined threshold value may be determined as the printout image PM1 corresponding to the preview image PV1. Alternatively, an image for pattern matching (a dedicated matching image) corresponding to each printout image PM may be stored in the storage unit 5, and the printout image PM1 corresponding to the preview image PV1 may be specified on the basis of the degree of similarity between each dedicated matching image and the preview image PV1. In particular, the speed of pattern matching can be increased by using dedicated matching images that have a lower resolution than the printout images PM.

Then, in step S37, the printout control unit 11 of the MFP 10 performs printout or the like of the printout image PM1 specified by the analysis unit 15.

Through the operations described above, the printout image PM1 corresponding to the preview image PV1 specified by the e-mail ML3 is printed out in response to the receipt of the e-mail ML3.

In this way, it is possible to determine that the printout instruction PD is provided if the e-mail ML3 (generated via the e-mail ML2) contains a character string indicating that the e-mail ML3 is an e-mail related to the e-mail ML1. Alternatively, the printout image PM1 may be specified (identified) on the basis of the preview image PV1 attached to the e-mail ML3.

While in the present example, the printout image PM1 corresponding to the preview image PV1 is specified using a pattern matching technique, the present invention is not limited to this. For example, the MFP 10 may give a filename “unique number 555.pdf” to the attached file (the preview image PV1) in the e-mail ML2, and the preview image PV1 having that filename may be attached as-is to the e-mail ML3. Then, the MFP 10 (the analysis unit 15) may specify the printout image PM1 corresponding to the preview image PV1, using the words “unique number 555” contained in the filename of the attached file (the preview image PV1) in the e-mail ML3.

### 2. Second Embodiment

A second embodiment is a variation on the first embodiment. The following description therefore focuses on differences from the first embodiment.

The above first embodiment describes a mode in which the e-mail ML1 specifies a single print setting “2-in-1.”

The second embodiment describes a mode in which a plurality of print settings (specifically, three print settings “zoom,” “image shift,” and “2-in-1”) are combined and specified in the e-mail ML1. In the second embodiment, it is further determined whether or not a setting (hereinafter, also referred to as a “composite setting” or a “combination setting”) that is a combination of print settings is a “prohibited combination setting” (a combination of print settings that is prohibited from use). When it is determined that the composite setting is a prohibited combination setting, at least one of available composite settings selected from among a plurality of composite settings is determined as an alternative. Then, a preview image PV corresponding to the alternative is presented to the user UA.

The following is a detailed description of this mode.

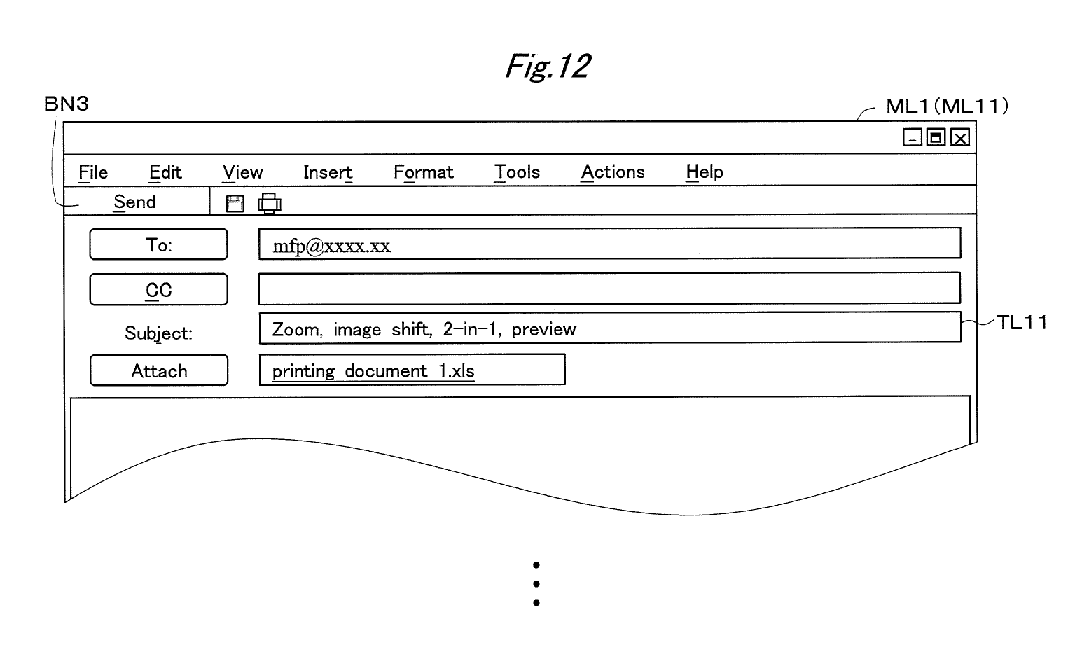

FIG. 12 shows an e-mail ML1 (ML11) according to the second embodiment. As shown in FIG. 12, a character string “zoom, image shift, 2-in-1, preview” is written in a subject field TL11 of the e-mail ML11. In this way, the e-mail ML1 (ML11) in FIG. 12 differs from the e-mail ML1 in FIG. 5 in that three print settings (specifically, “zoom,” “image shift,” and “2-in-1”) are written in the subject field. Note that detail parameters (e.g., a zoom rate) of the print settings “zoom” and “image shift” may be default values set by the MFP 10. To be specific, a default value (e.g., “70%”) for the zoom rate may be applied as the print setting “zoom”. The same applies to detail parameters such as a shift direction and a shift amount for the print setting “image shift,” and default values (e.g., “upward” and “10 mm”) may be applied as the respective parameters.

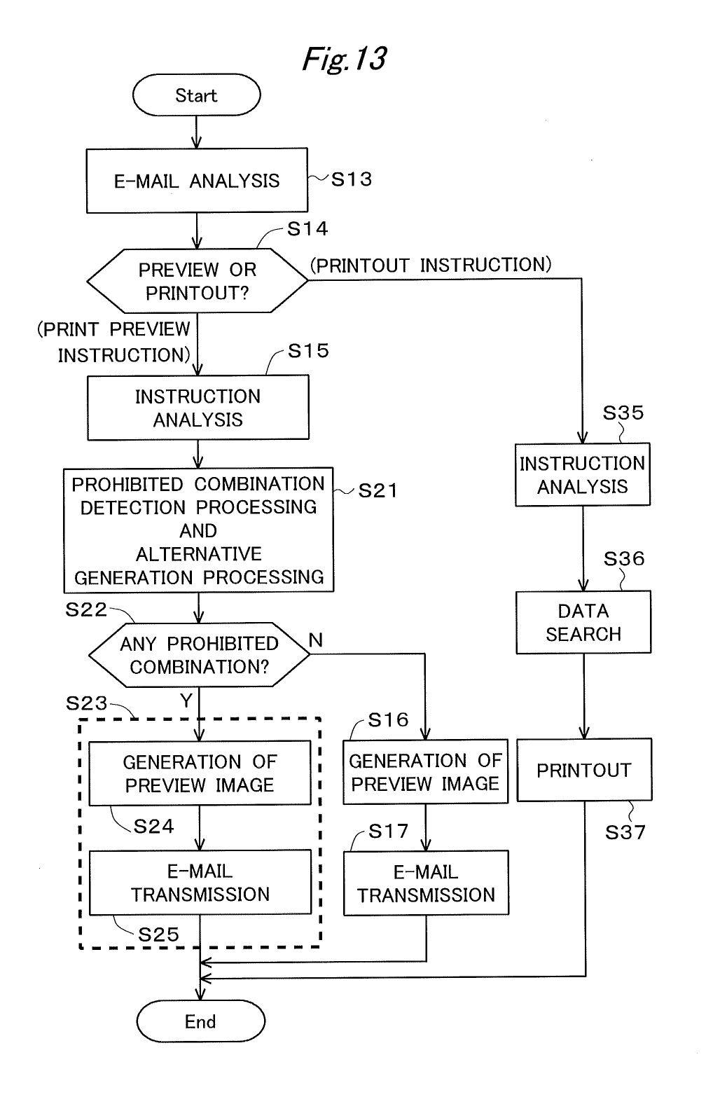

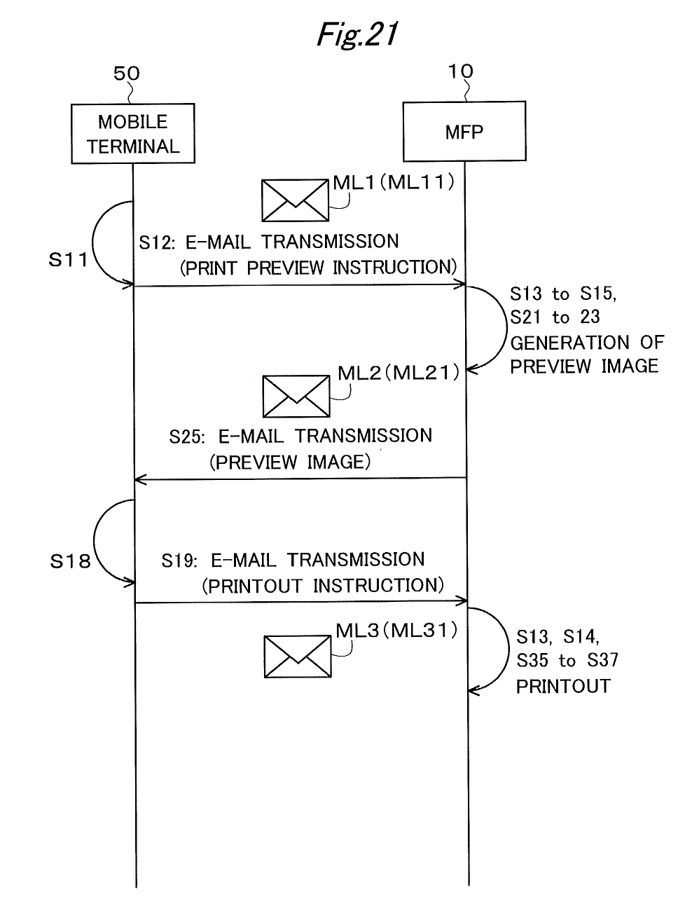

FIG. 13 is a flowchart of operations performed by the MFP 10 according to the second embodiment. FIG. 21 illustrates operations performed in the system 1 according to the second embodiment.

The processing of steps S11 to S17 and S35 to S37 in FIGS. 21 and 13 is the same as that in FIGS. 3 and 4. On the other hand, processing of steps S21 to S23 is additionally performed in FIG. 13. The e-mails ML1 to ML3 (in particular, ML2 and ML3) are also different from those in the first embodiment (see FIGS. 21 to 23).

Upon receiving the e-mail ML1 in FIG. 12, the MFP 10 performs the processing of steps S13, 514, and S15 as in the first embodiment.

Next, in step S21, the MFP 10 (the analysis unit 15) determines whether or not the print setting information written in the subject field TL11 of the e-mail ML1 (ML11) (FIG. 12) is implementable. Specifically, it is determined whether or not the composite setting CS that is the aforementioned combination of the three print settings is a “prohibited combination setting” (a combination of print settings that is prohibited from use). Assume here that among the three print settings, a combination of the print settings “zoom” and “image shift” makes a “prohibited combination setting.” It is thus determined that the above composite setting CS (“zoom,” “image shift,” and “2-in-1”) including the combination of the print settings “zoom” and “image shift” is a prohibited combination setting. Note that there are various prohibited combination settings (e.g., a setting including the combination of “zoom” and “image shift”) depending on, for example, the device configuration (hardware) and/or software specification of the MFP 10.

When it is determined that a setting (composite setting) CS that is a combination of a plurality of print settings is a prohibited combination setting, the MFP 10 (the analysis unit 15) determines at least one of available composite settings (including a composite setting consisting of only a single print setting) among a plurality of composite settings of a plurality of print settings as an alternative. Specifically, at least two of available composite settings among a plurality of composite settings, each consisting of a combination of at least one of the plurality of print settings, are determined as alternatives. In a specific example, among a plurality of (a total of six) composite settings of the above three print settings, the following five available composite settings ST1 to ST5 are determined as alternatives (candidates for a composite setting that can replace the specified composite setting CS (“zoom,” “image shift,” and “2-in-1”)).

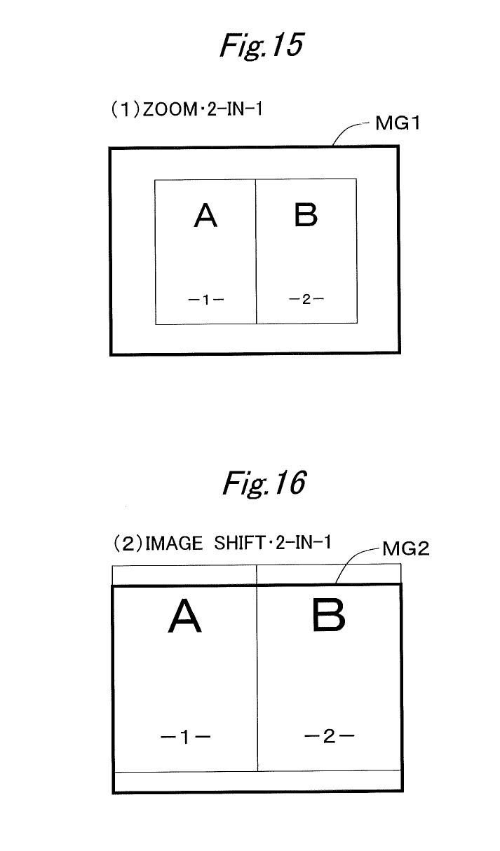

(1) ST1: “zoom” and “2-in-1” (see FIG. 15);

(2) ST2: “image shift” and “2-in-1” (see FIG. 16);

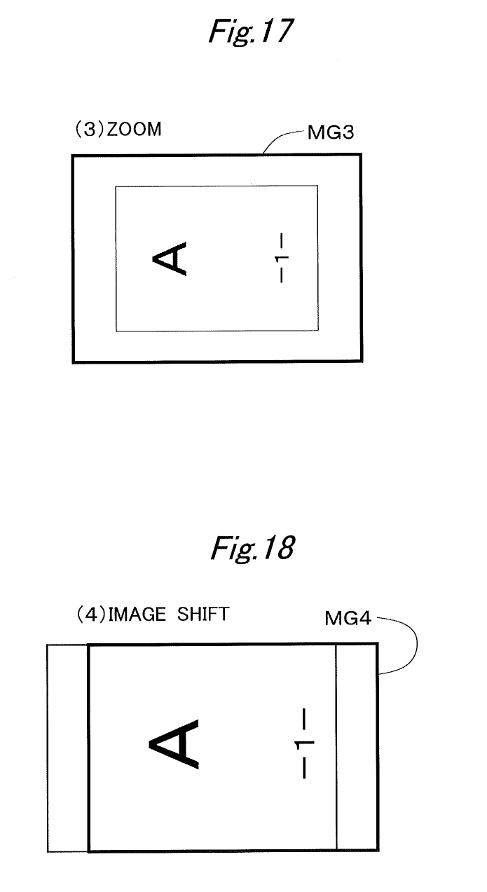

(3) ST3: “zoom” only (see FIG. 17);

(4) ST4: “image shift” only (see FIGS. 18); and

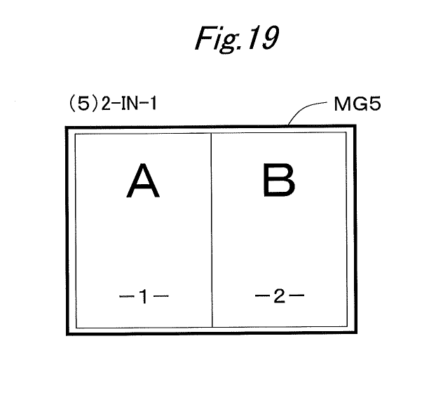

(5) ST5: “2-in-1” only (see FIG. 19).

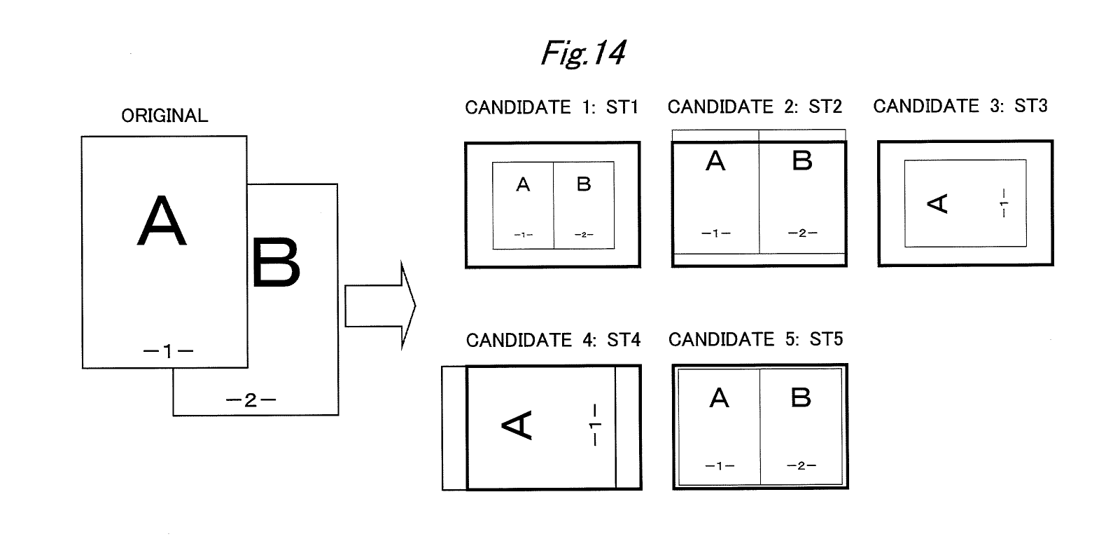

In other words, the above five composite settings are determined as available composite settings (non “prohibited combination settings”). FIG. 14 schematically illustrates these five different composite settings ST1 to ST5 as five candidates (alternatives).

Next, the processing branches in step S22 according to the result of the prohibited-combination detection processing in step S21.

If it is determined in step S22 that a composite setting CS that is a combination of print settings is not a prohibited combination setting, the processing proceeds from step S22 to step S16. For example, if only the two print settings “zoom” and “2-in-1” are specified in the e-mail ML1, a preview image is generated using a composite setting that is a combination of the two print settings (“zoom” and “2-in-1”) (step S16). Then, the generated preview image is attached to the e-mail ML2 and sent to the mobile terminal 50 (step S17). Note that the details of the operations are the same as in the first embodiment or the variations on the first embodiment.

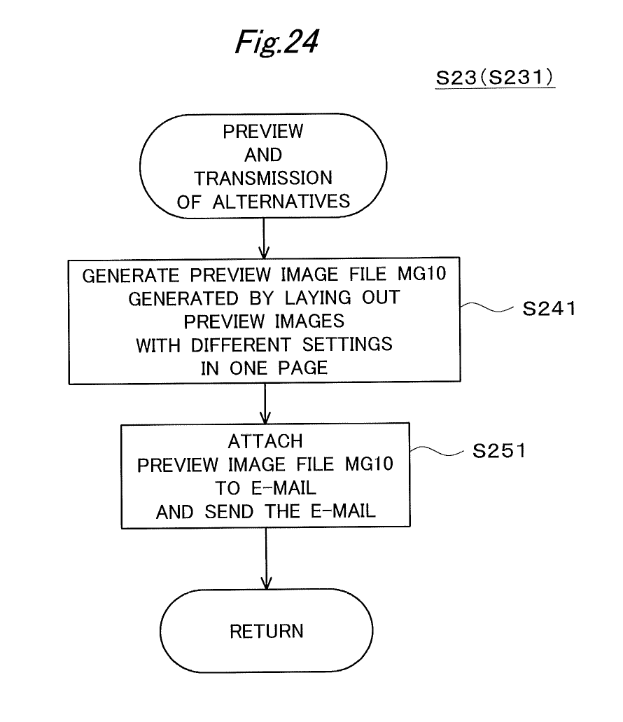

On the other hand, if it is determined in step S22 that the composite setting CS that is the combination of the print settings corresponds to a prohibited combination setting, the processing proceeds from step S22 to step S23 (S231 in FIG. 24). FIG. 24 is a flowchart showing the detailed processing performed in step S23 (S231).

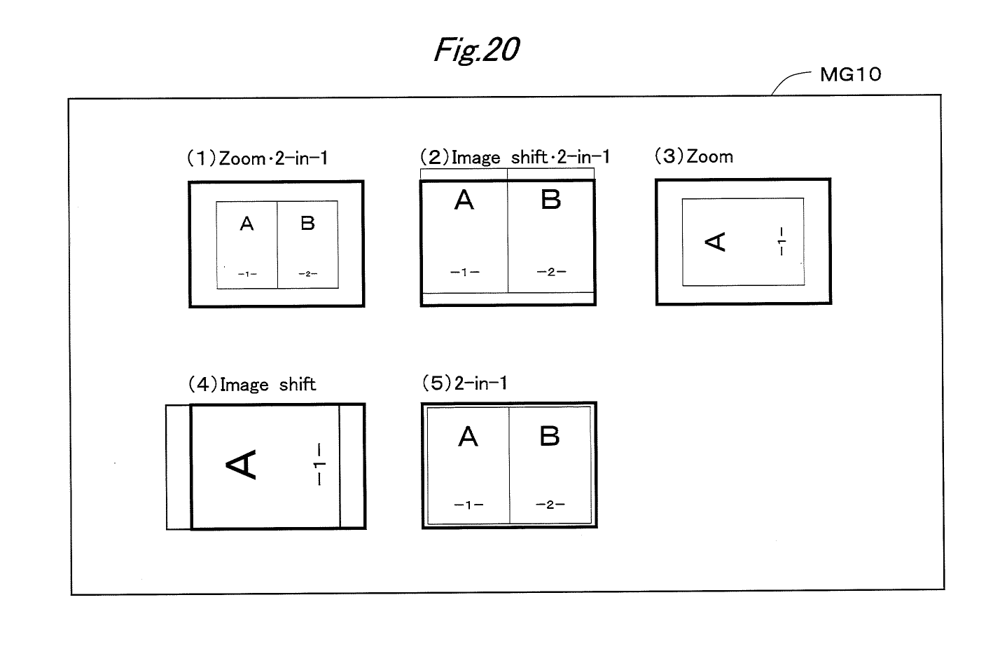

In step S24 (S241), the MFP 10 (the generation unit 16) generates individual preview images MG1 to MG5 that correspond respectively to the above five different composite settings ST1 to ST5 (FIGS. 15 to 19). In the present example, the MFP 10 also generates a preview image MG10 (FIG. 20) that consolidates a plurality of preview images by combining the individual preview images MG1 to MG5 corresponding to the five different composite settings.

When generating the preview images MG1 to MG5, the MFP 10 (the generation unit 16) also generates five different printout images PM11 to PM15 that correspond respectively to the five different composite settings ST1 to ST5 and stores the printout images PM11 to PM15 into the storage unit 5.

In step S25, the MFP 10 (the analysis unit 15 and the mail sending unit 14) generates an e-mail ML2 as a reply to the mobile terminal 50 and attaches the preview images corresponding to the above five different composite settings to the e-mail ML2.

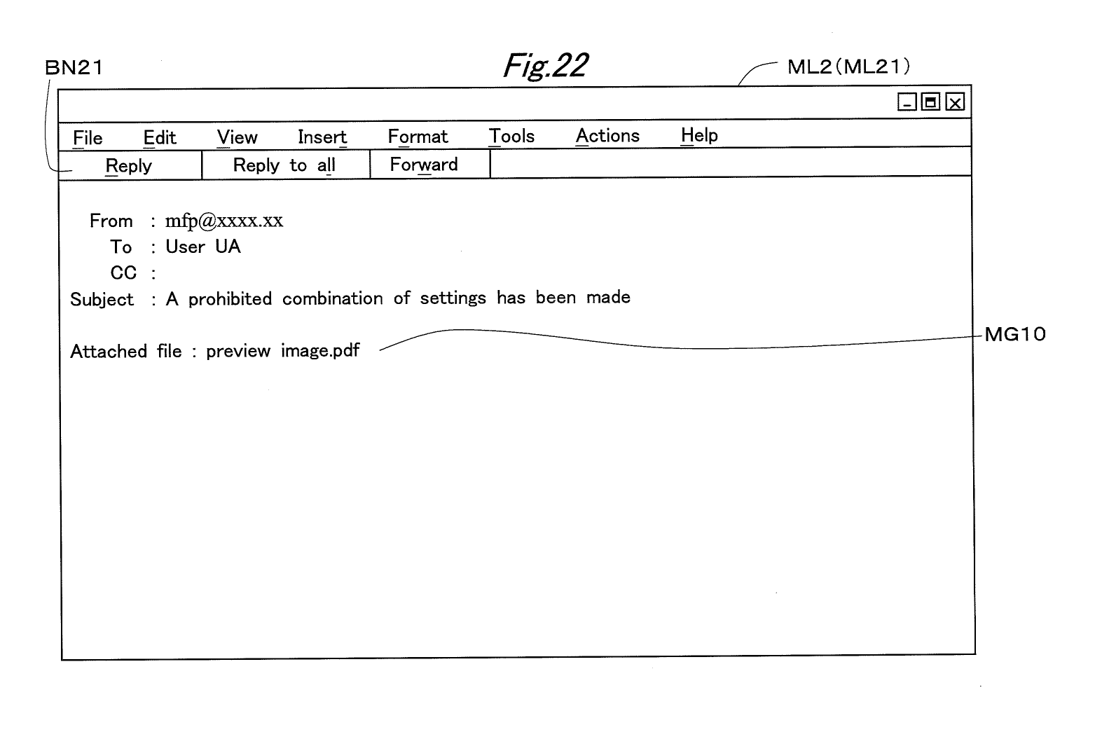

It is assumed here that the single preview image MG10 (FIG. 20) generated by combining the individual preview images MG1 to MG5 corresponding to the five different composite settings ST1 to ST5 is attached to the single e-mail ML2 (ML21). The MFP 10 (the analysis unit 15 and the mail sending unit 14) also writes a character string “A prohibited combination of settings has been made” in the subject line of the e-mail ML2 (ML21) (FIG. 22), which is a return e-mail to the mobile terminal 50. It can also be said that this character string indicates that the composite setting CS specified in the e-mail ML1 (ML11) corresponds to a prohibited combination setting. Then, the mail sending unit 14 of the MFP 10 sends the e-mail ML21 to the mobile terminal 50 (the user UA) (see step S25).

Meanwhile, the user UA receives the e-mail ML21 on the mobile terminal 50 and browses the e-mail ML21 and its attached file (preview image MG10), using the mobile terminal 50 (step S18 in FIG. 21).

The user UA browses the preview image MG10 (FIG. 20) and selects a desired alternative from among the five alternatives. Then, an e-mail ML3 (ML31) that includes a printout instruction to print out the printout image PM for the selected alternative is generated through an operation of the user UA.

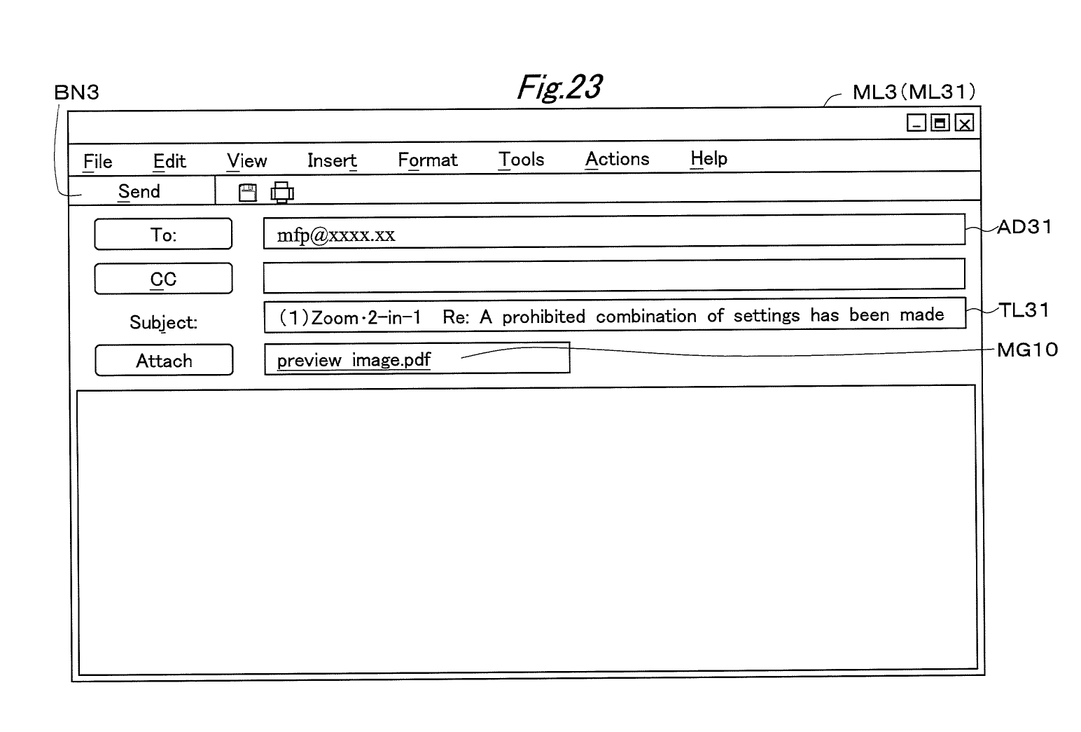

FIG. 23 shows the e-mail ML3 (ML31). As shown in FIG. 23, the preview image MG10 is attached to the e-mail ML31. The preview image MG10 is attached to the e-mail ML3 through, for example, an operation performed on the area for displaying the attached filename in the e-mail ML21. Also, a character string “(1) zoom. 2-in-1” is additionally written by the user UA in front of the character string “Re: A prohibited combination of settings has been made” in a subject field TL31. The character string “(1) zoom 2-in-1” indicates that a specific composite setting ST1 (“zoom” and “2-in-1”) has been selected from among the above five alternatives (composite settings ST1 to ST5).

Then, the mobile terminal 50 sends the e-mail ML3 (ML31) to the MFP 10 in accordance with an operation of the user UA (step S19 in FIG. 21).

Upon receiving the e-mail ML31 (FIG. 23), the MFP 10 performs the processing of steps S13, S14, S35, S36, and S37 (see FIG. 13) so as to perform printout with the composite setting ST1 on the basis of the e-mail ML3 and the like.

Specifically, the MFP 10 first analyzes the e-mail ML31 (step S13 in FIG. 13).

If it is determined that the e-mail ML31 includes the character string “Re: A prohibited combination of settings has been made,” which indicates that the e-mail ML31 is an e-mail related to the print preview instruction VD, the MFP 10 determines that the e-mail ML31 provides the printout instruction PD. The processing then proceeds from step S14 to step S35.

Furthermore, the operation of analyzing the printout instruction PD (step S35), the operation of specifying the printout image PM specified in the printout instruction PD (step S36), and the printout operation (step S37) are performed.

Specifically, the analysis unit 15 of the MFP 10 first determines that the printout instruction PD to print out the printout image PM1 corresponding to the composite setting ST1 among the individual preview images included in the attached file MG10 has been provided (step S35).

To be more specific, the analysis unit 15 recognizes that the character string “(1) zoom •2-in-1” written in the subject field TL31 of the e-mail ML31 indicates the desired composite setting among the composite settings ST1 to ST5. The analysis unit 15 then recognizes the composite setting ST1 (“zoom” and “2-in-1”) corresponding to the character string “(1) zoom •2-in-1” as the desired composite setting. The analysis unit 15 also extracts the preview image MG10 from the received e-mail ML31 and breaks the preview image MG10 down into five individual preview images PV21 to PV25 (images that correspond respectively to the images MG1 to MG5). The analysis unit 15 then extracts the preview image PV21 corresponding to the character string “(1) zoom •2-in-1” (the image corresponding to the image MG1 in FIG. 15) from among the broken-down five individual preview images PV21 to PV25 as a preview image corresponding to the desired composite setting ST1. Although in the present example, the character string “(1) zoom •2-in-1” corresponding to the desired one of at least two composite settings is written in the subject field TL31 of the e-mail ML31, the present invention is not limited to this. For example, such a character string (text information) may be written in the body of the e-mail ML31, and the character string written in the body may be analyzed so that the composite setting desired by the user UA can be recognized.

Then, the analysis unit 15 specifies the printout image PM11 corresponding to the preview image PV21, using the preview image PV21. Specifically, the analysis unit 15 uses a pattern matching technique or the like to specify the printout image PM11 corresponding to the preview image PV21 from among multiple printout images PM stored in the storage unit 5 (step S36). In this way, one printout image PM11 to be printed is specified from among the multiple printout images PM that include the printout images PM11 to PM15 corresponding to the preview images PV21 to PV25.

Then, in step S37, the printout control unit 11 of the MFP 10 prints out the printout image PM11 specified by the analysis unit 15. Upon completion of the printout of the printout image PM11 in step S37, the printout control unit 11 deletes the printout image PM11 from the storage unit 5. Note that the printout images PM12 to PM14 may also be deleted from the storage unit 5 in response to the completion of the printout of the printout image PM11.

As described above, upon receiving the e-mail ML1 in which the setting information regarding a combination of a plurality of print settings is written, the MFP 10 determines whether or not the composite setting CS that is the combination of print settings is a prohibited combination setting (step S21).

When it is determined that the composite setting CS specified in the e-mail ML1 is a prohibited combination setting, at least two of available composite settings among a plurality of composite settings, each consisting of at least one of the plurality of print settings, are determined as alternatives (step S21). Then, the plurality of preview images MG1 to MG5 corresponding to these alternatives are generated, and the image MG10 generated by consolidating the preview images MG1 to MG5 is attached to the e-mail ML2 and sent toward the mobile terminal 50 (user UA) (step S23 (S231)). The user UA can thus easily browse the preview images MG1 to MG5 as the alternatives. In particular, the preview images of a file to be printed (the preview images PV as the alternatives) can be easily browsed even on the mobile terminal 50 in which a printer driver is not installed.

In particular, the MFP 10 receives the e-mail ML31 that includes the printout instruction PD to print out one of the plurality of preview images MG1 to MG5 from the mobile terminal 50. The MFP 10 then prints out a printout image corresponding to one of the preview images (the printout image corresponding to the desired composite setting) in accordance with the printout instruction PD. For example, the printout image PM1 corresponding to the preview image specified in the e-mail ML31 is printed out in response to the receipt of the e-mail ML31. Accordingly, by sending the e-mail ML31, the user UA can easily print out a printout image corresponding to the desired composite setting among at least two composite settings serving as the alternatives.

### 3. Third Embodiment

A third embodiment is a variation on the second embodiment. The following description therefore focuses on differences from the second embodiment.

The above second embodiment describes a mode in which the image data MG10 (FIG. 20) generated by consolidating the preview images MG1 to MG5 is attached to and sent with the single e-mail ML2 (ML21) (see FIGS. 21 and 22, for example).

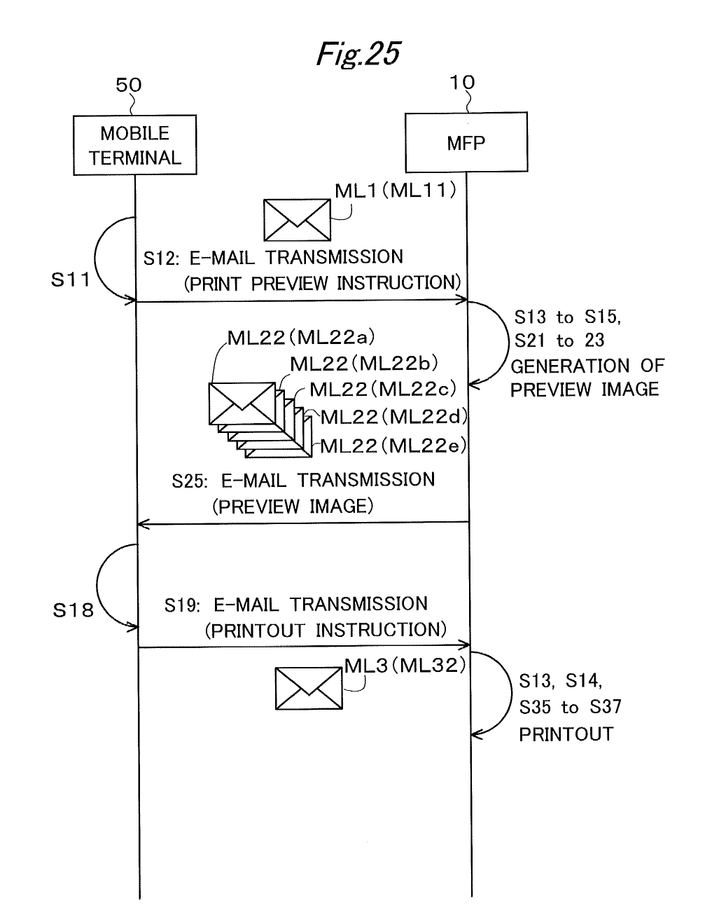

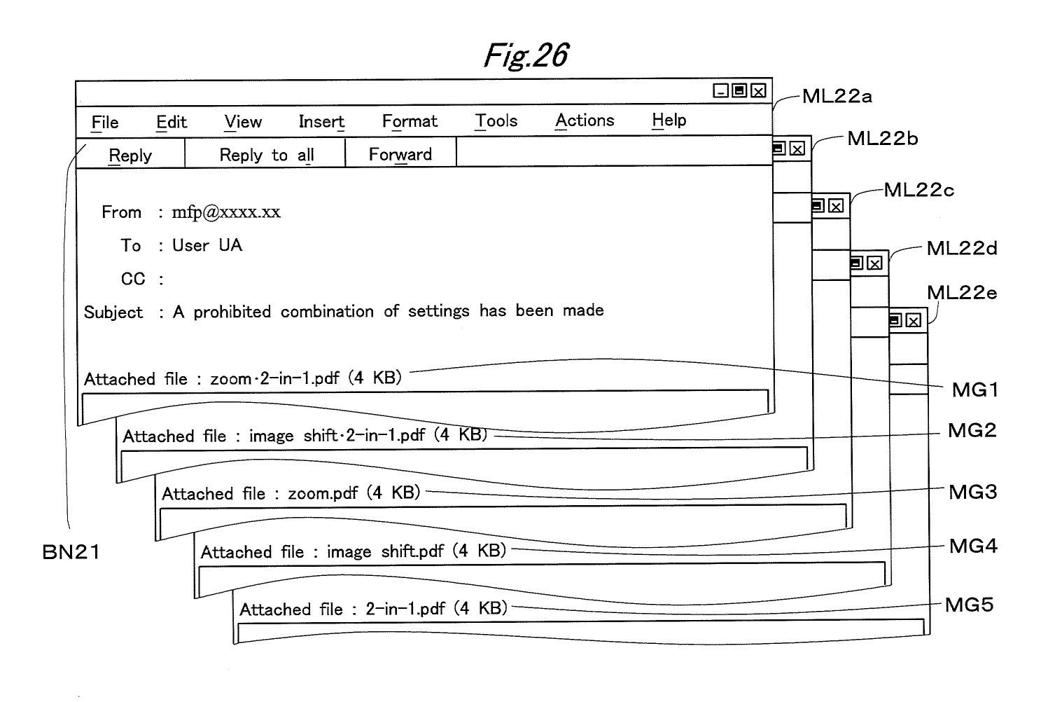

The third embodiment describes a mode in which a plurality of preview images MG1 to MG5 are respectively and separately attached to and sent with a plurality of e-mails ML2 (ML22a to ML22e) (see FIGS. 25 and 26, for example).

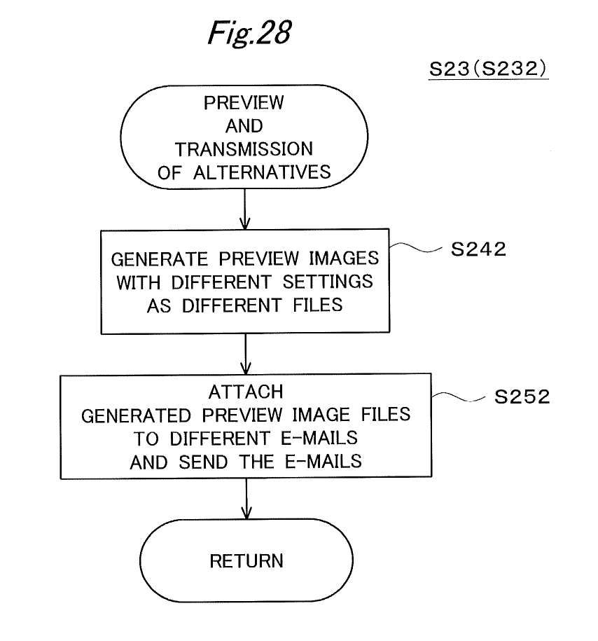

FIG. 25 illustrates operations performed in the system 1 according to a third embodiment. The MFP 10 according to the third embodiment performs the same operations as in FIG. 13, with the exception that operations as shown in FIG. 28 are performed in step S23.

As illustrated in FIG. 28, the MFP 10 (the generation unit 16) generates individual preview images MG1 to MG5 corresponding to the above five different composite settings ST1 to ST5 in step S24 (S242). In step S24, the MFP 10 (the generation unit 16) also generates five different printout images PM11 to PM15 corresponding to the five different composite settings ST1 to ST5 and stores the printout images PM11 to PM15 into the storage unit 5.

Then, in step S25 (S252), the MFP 10 (the analysis unit 15 and the mail sending unit 14) generates five e-mails ML22 (e-mails ML22a to ML22e) for reply to the mobile terminal 50. The preview images MG1 to MG5 corresponding to the above five different composite settings are each attached to the corresponding one of the five e-mails ML22 (see FIG. 26). Specifically, the preview image MG1 is attached to the e-mail ML22a, and the preview image MG2 is attached to the e-mail ML22b. Similarly, the preview image MG3 is attached to the e-mail ML22c, the preview image MG4 is attached to the e-mail ML22d, and the preview image MG5 is attached to the e-mail ML22e.

The MFP 10 (the mail sending unit 14) then sends these five e-mails ML22a, ML22b, ML22c, ML22d, and ML22e to the mobile terminal 50 (the user UA).

Meanwhile, the user UA receives the five e-mails ML22a to ML22e on the mobile terminal 50 and browses the attached files (the preview images MG1 to MG5) in the respective e-mails ML22a to ML22e, using the mobile terminal 50 (step S18 in FIG. 25).

The user UA browses the five preview images MG1 to MG5 (FIGS. 15 to 19) and selects a desired alternative from among the five alternatives.

Then, an e-mail ML3 (ML32) that includes a printout instruction to print out a printout image PM for the selected alternative is generated through an operation of the user UA.

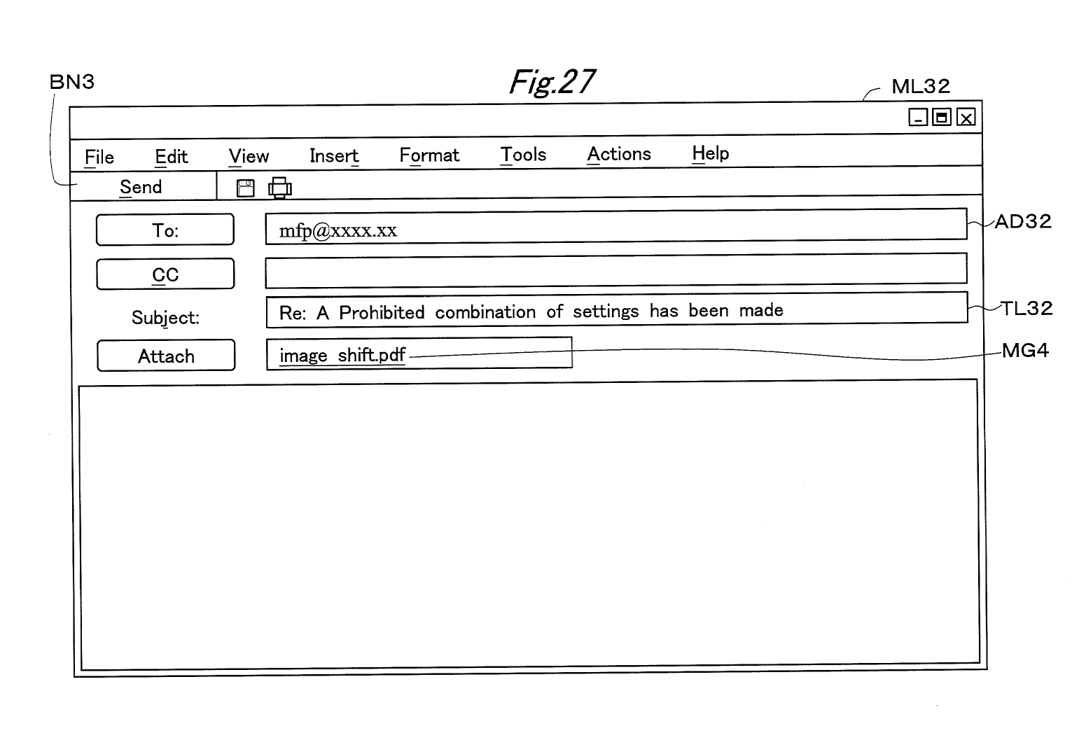

Specifically, after having determined the desired alternative, the user UA presses the reply button in the e-mail ML22 (e.g., the e-mail ML22d) to which the preview image for the desired alternative is attached, among the plurality of e-mails ML22. In response to this pressing of the button, the mailer PG5 of the mobile terminal 50 generates an e-mail ML32 (a return e-mail addressed to the MFP 10) as shown in FIG. 27. The mailer PG5 also automatically attaches the preview image MG4 attached to the e-mail ML22 to the e-mail ML32. Accordingly, the preview image MG4 (“image shift.pdf”) is attached to the e-mail ML32 as shown in FIG. 27. Note that the preview image MG4 may be attached to the e-mail ML32 through an operation of the user UA.

Then, the mobile terminal 50 sends the e-mail ML3 (ML32) to the MFP 10 in accordance with an operation of the user UA (step S19 in FIG. 25).

Upon receipt of the e-mail, the MFP 10 performs the processing of steps S13, S14, S35, S36, and S37 (see FIG. 13) to perform printout with the composite setting ST4 on the basis of the e-mail ML32 and the like.

The processing of steps S13 and S14 is the same as in the second embodiment. The operation of analyzing the printout instruction PD (step S35), the operation of specifying the printout image PM specified in the printout instruction PD (step S36), and the printout operation (step S37) are further performed.

Specifically, first, the analysis unit 15 of the MFP 10 determines that the printout instruction PD to print out the printout image PM corresponding to the attached file MG (MG4) in the e-mail ML32 has been provided (step S35).

The analysis unit 15 also extracts the preview image MG4 from the received e-mail ML32 and specifies the printout image PM14 corresponding to the preview image MG4, using the preview image MG4. Specifically, the analysis unit 15 uses a pattern matching technique or the like to specify the printout image PM14 corresponding to the preview image MG4 from among multiple printout images PM stored in the storage unit 5 (step S36). In this way, one printout image PM14 to be printed is specified from among the multiple printout images PM (including the printout images PM11 to PM15 corresponding to the preview images MG1 to MG5), using the preview image MG4 attached to the e-mail ML32.

Then, in step S37, the printout control unit 11 of the MFP 10 prints out the printout image PM14 specified by the analysis unit 15. Upon completion of the printout of the printout image PM14 in step S37, the printout control unit 11 deletes the printout image PM14 from the storage unit 5. Note that the printout images PM11 to PM13 and PM15 may also be deleted from the storage unit 5 in response to the completion of the printout of the printout image PM14.

In the mode described above, the e-mails ML22a to ML22e to which the preview images MG1 to MG5 as the alternatives are respectively and separately attached are sent from the MFP 10 to the mobile terminal 50 (the user UA) (step S23 (S232)) (see FIGS. 25 and 26). The user UA can thus easily browse the preview images MG1 to MG5 as the alternatives. In particular, the preview images of files to be printed (the preview images PV as the alternatives) can be easily browsed even on the mobile terminal 50 in which a printer driver is not installed.

In addition, the e-mail ML32 that includes the printout instruction PD to print out one of the preview images MG1 to MG5 is transmitted from the mobile terminal 50 to the MFP 10. In response to the receipt of the e-mail ML32, the MFP 10 prints out the printout image PM14 corresponding to the preview image MG4 specified in the e-mail ML32. Accordingly, by sending the e-mail ML32, the user UA can easily print out a printout image that corresponds to the desired one of at least two composite settings according to the alternatives.

### 4. Fourth Embodiment

A fourth embodiment is a variation on the second embodiment (and the third embodiment). The following description therefore focuses on differences from the second embodiment.

The fourth embodiment describes a mode in which a plurality of preview images MG1 to MG5 are attached to and sent with a single e-mail ML2 (ML23) and sent.

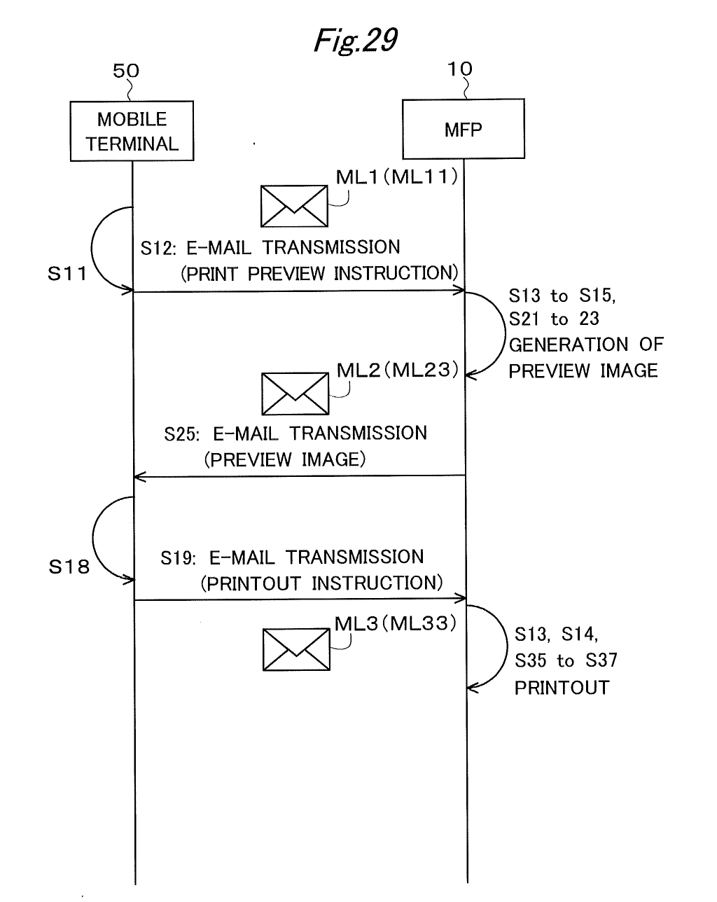

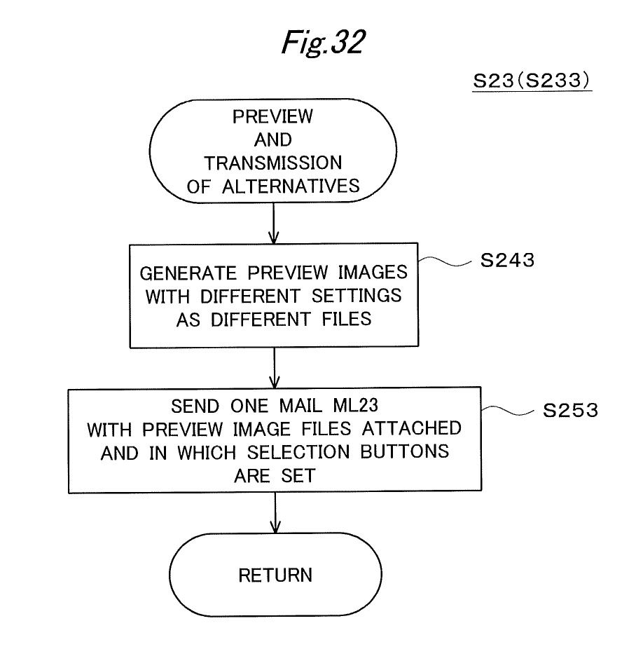

FIG. 29 illustrates operations performed in the system 1 according to the fourth embodiment. The MFP 10 according to the fourth embodiment performs the same operations as in FIG. 13, with the exception that operations as illustrated in FIG. 32 are performed in step S23 (S233).

As illustrated in FIG. 32, the MFP 10 (the generation unit 16) generates the individual preview images MG1 to MG5 corresponding to the above five different composite settings ST1 to ST5 in step S24 (S243). In step S24, the MFP 10 (the generation unit 16) also generates five different printout images PM11 to PM15 corresponding to the five different composite settings and stores the printout images PM11 to PM15 into the storage unit 5.

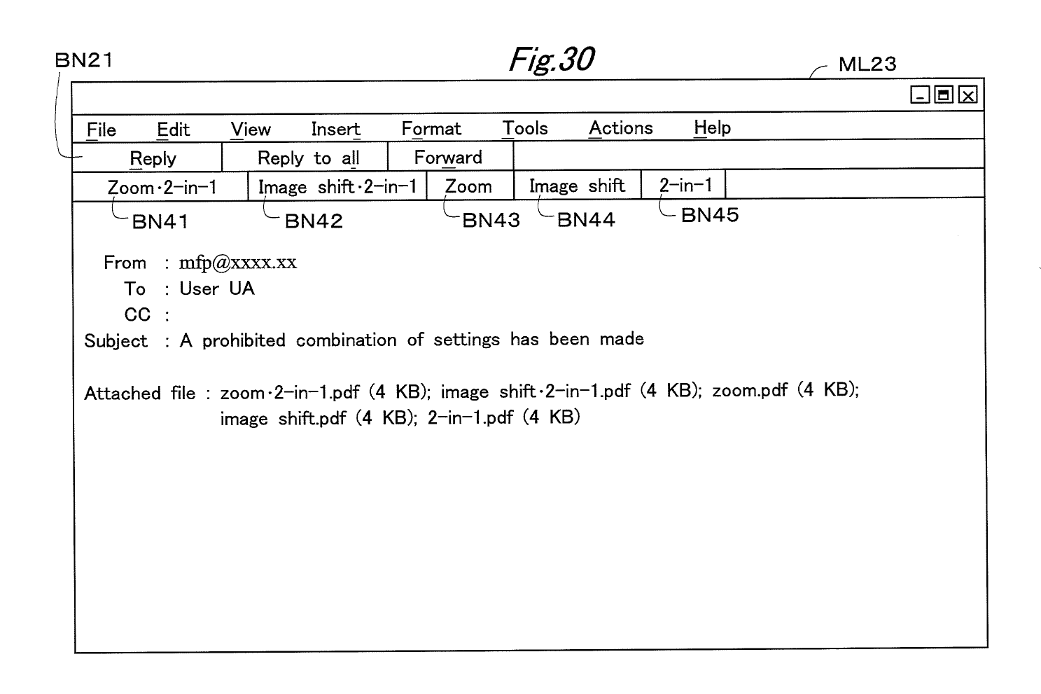

Then, in step S25 (S253), the MFP 10 (the analysis unit 15 and the mail sending unit 14) generates a single e-mail ML23 for reply to the mobile terminal 50. The five preview images MG1 to MG5 corresponding to the above five different composite settings are all attached to the e-mail ML23 (see FIG. 30).

The e-mail ML23 has embedded therein data for displaying a plurality of reply buttons BN41 to BN45. For example, in the case where the mailer PG5 is specific mail client software “OUTLOOK” (registered trademark), a command for controlling the specific mail client software is written in the header part of the e-mail ML23. Note that this control command also includes the content of processing performed when the buttons BN41 to BN45 are pressed.

Thus, as shown in FIG. 30, the reply buttons BN41 to BN45 can be displayed in the window (specifically, the menu part of the window) for browsing the e-mail ML23 when the e-mail ML23 is displayed by the specific mail client software “OUTLOOK” (registered trademark). The reply buttons BN41 to BN45 can also be said to be selection buttons for selecting the desired one of at least two composite settings according to the alternatives.

Then, the MFP 10 (the mail sending unit 14) sends the e-mail ML23 to the mobile terminal 50 (the user UA) (step S253).

Meanwhile, the user UA receives the e-mail ML23 on the mobile terminal 50 and browses the e-mail ML23 and its attached files (the preview images MG1 to MG5), using the mobile terminal 50 (step S18 in FIG. 29).

The user UA browses the five preview images MG1 to MG5 (FIGS. 15 to 19) and selects a desired alternative from among the five alternatives.

After having determined the desired alternative, the user UA presses a button corresponding to the desired alternative (e.g., the button BN43) from among the five types of buttons BN41 to BN45 displayed in the window of the mobile terminal 50 for displaying the e-mail ML23. The button BN41 corresponds to the composite setting ST1, and the button BN42 corresponds to the composite setting ST2. Similarly, the button BN43 corresponds to the composite setting ST3, the button BN44 corresponds to the composite setting ST4, and the button BN45 corresponds to the composite setting ST5.

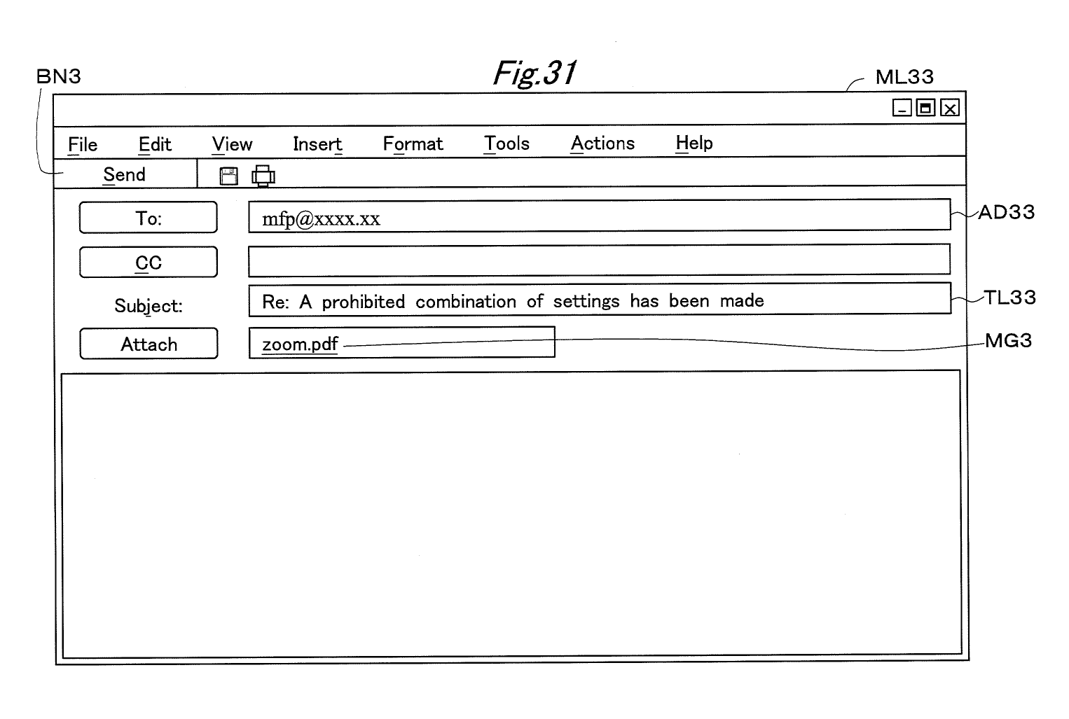

When the user UA has pressed the button BN43 corresponding to the composite setting ST3, the control command (the control command corresponding to the button BN43) embedded in the e-mail ML23 is executed in response to the pressing of the button BN43. Specifically, the mailer PG5 (the mail client software “OUTLOOK” (registered trademark)) of the mobile terminal 50 automatically generates an e-mail ML33 (a return e-mail addressed to the MFP 10) as shown in FIG. 31. The mailer PG5 also automatically attaches the preview image MG3 (“zoom.pdf”) corresponding to the button BN43 among the preview images MG1 to MG5 attached to the e-mail ML23, to the e-mail ML33. Then, the e-mail ML3 (ML33) is automatically sent from the mobile terminal 50 to the MFP 10 (step S19 in FIG. 29).

In this way, in response to the user UA pressing the desired button BN43, the e-mail ML33 with the preview image MG3 attached is automatically generated and automatically sent to the MFP 10. In other words, the mobile terminal 50 automatically generates and automatically sends the e-mail ML3 (ML33) that includes a printout instruction to print out the printout image PM for the selected alternative.

Upon receiving the e-mail ML33, the MFP 10 performs the processing of steps S13, S14, S35, S36, and S37 (see FIG. 13) to perform printout with the composite setting ST3 on the basis of the e-mail ML33 or the like.

The processing of steps S13 and S14 is the same as in the second embodiment. Furthermore, the operation of analyzing the printout instruction PD (step S35), the operation of specifying the printout image PM specified in the printout instruction PD (step S36), and the printout operation (step S37) are performed.

Specifically, first, the analysis unit 15 of the MFP 10 determines that the printout instruction PD to print out the printout image PM corresponding to the attached file in the e-mail ML33 has been provided (step S35).

The analysis unit 15 also extracts the preview image MG (MG3) from the received e-mail ML33 and specifies the printout image PM13 corresponding to the preview image MG3, using the preview image MG3. Specifically, the analysis unit 15 uses a pattern matching technique or the like to specify the printout image PM13 corresponding to the preview image MG3 from among multiple printout images PM stored in the storage unit 5 (step S36).

Then, in step S37, the printout control unit 11 of the MFP 10 prints out the printout image PM13 specified by the analysis unit 15. Upon completion of the printout of the printout image PM13 in step S37, the printout control unit 11 deletes the printout image PM13 from the storage unit 5. Note that the printout images PM11, PM12, PM14, and PM15 may also be deleted from the storage unit 5 in response to the completion of printout of the printout image PM13.

In the mode as described above, the single e-mail ML23 to which all of the preview images MG1 to MG5 corresponding to the alternatives are attached is sent from the MFP 10 to the mobile terminal 50 (the user UA) (step S23 (S233)) (see FIGS. 28 to 30). The user UA can thus easily browse the preview images MG1 to MG5 as the alternatives. In particular, the preview images of files to be printed (the preview images PV for the alternatives) can be easily browsed even on the mobile terminal 50 in which a printer driver is not installed.

In particular, the e-mail ML23 has embedded therein the data for displaying the buttons BN41 to BN45, and in response to the pressing of one of the buttons BN41 to BN45, the e-mail ML33 is automatically generated and automatically sent to the MFP 10. The e-mail ML33 includes the printout instruction PD to print out one printout image corresponding to the pressed button (e.g., BN43) (e.g., the printout image PM13 corresponding to the preview image MG3).

This makes it possible to automatically generate and automatically send the e-mail ML3 to the MFP 10 without requiring the user UA to perform an operation of generating the e-mail ML3. The user UA can thus considerably easily print out the printout image PM13 corresponding to the desired composite setting ST3 among at least two composite settings according to the alternatives.

Although in the present example, the e-mail ML33 is automatically generated and sent in response to the pressing of one of the buttons BN41 to BN45, the present invention is not limited to this. For example, the e-mail ML33 may be automatically generated in response to the pressing of one of the buttons BN41 to BN45 and then may be sent in accordance with an operation of the user UA. In short, the e-mail ML33 may be sent manually.

### 5. Variations

While the above has been a description of embodiments of the present invention, the present invention is not intended to be limited to the embodiments described above.

### Variation on Fourth Embodiment

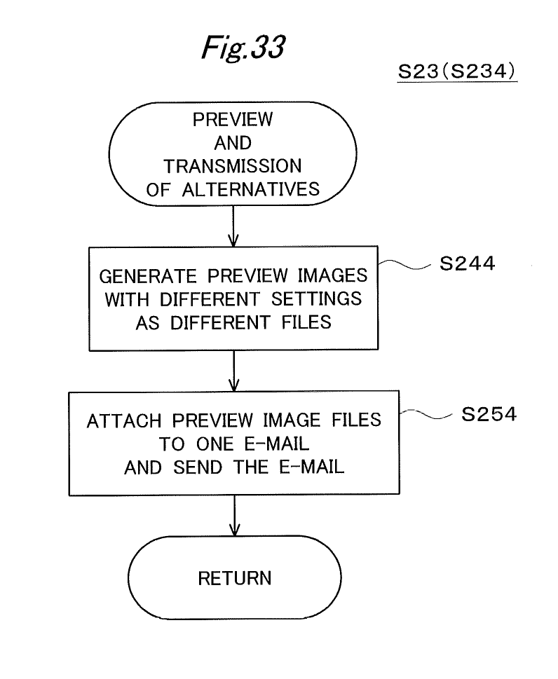

For example, although the above fourth embodiment describes a mode in which the buttons BN41 to BN45 are displayed in the e-mail ML23 (FIG. 30) and a corresponding preview image is automatically attached in response to the pressing of one of the buttons, the present invention is not limited to this. The window for displaying the e-mail ML23 may be configured not to display the buttons BN41 to BN45 (FIG. 30). Specifically, the e-mail ML2 may be generated without the data for displaying the buttons BN41 to BN45 being embedded therein in step S24 (S254) (FIG. 33). In this case, the e-mail ML33 may be generated in response to, for example, the pressing of the reply button BN21 (see FIG. 30) in the e-mail ML2, and the preview image MG3 corresponding to the desired composite setting ST3 may be (manually) attached to the e-mail ML33 (FIG. 31) through an operation of the user UA.

### Variation on Second to Fourth Embodiments

Although the pattern matching technique is used to specify a printout image PM corresponding to a composite setting ST in the above second to fourth embodiments, the present invention is not limited to this. For example, unique numbers that correspond to the composite settings ST1 to ST5 may be defined, and the desired printout image PM (e.g., PM11) may be specified using the unique numbers.

Specifically, first, the printout images PM11 to PM15 are stored in association with their unique numbers (“555-1,” “555-2,” “555-3,” “555-4,” and “555-5”) in step S24. These unique numbers are written in the e-mail ML21 and are thus presented to the user UA. Then, the user UA writes the unique number (e.g., “555-1”) corresponding to the desired composite setting (e.g., ST1) in the subject line or body of the e-mail ML3 (ML31). Thereafter, upon receipt of the e-mail ML3, the MFP 10 specifies the printout image PM11 using the unique number (“555-1”) written in the e-mail ML3 and prints out the printout image PM11. In this way, the printout image PM may be specified by the unique number.

### Variation on Combination-Prohibited Settings

Although the above second to fourth embodiments describe a mode in which the composite setting CS regarding the combination of three print settings (“zoom,” “image shift,” and “2-in-1”) is specified in the e-mail ML1, the present invention is not limited to this. The e-mail ML1 may specify a composite setting CS that is a combination of another plurality of print settings.

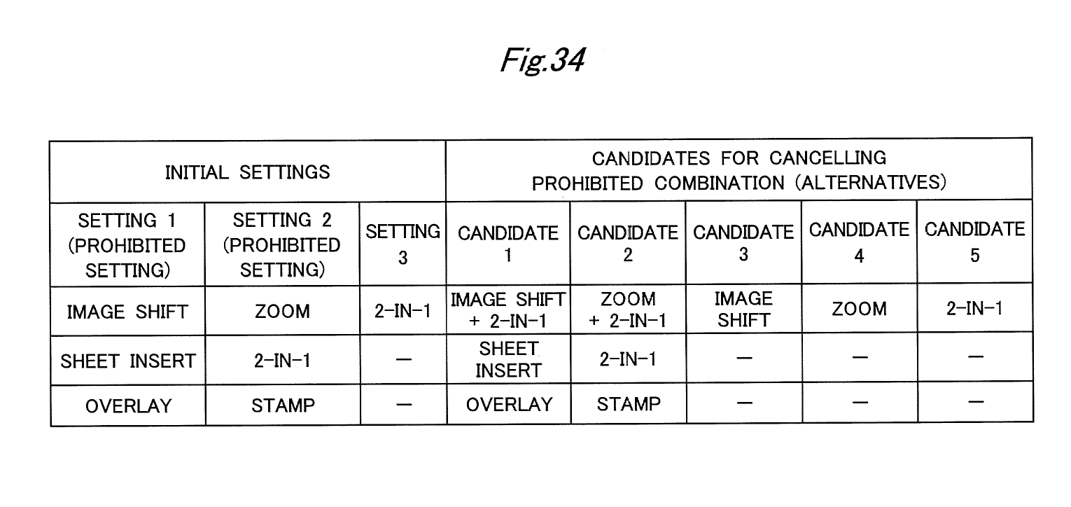

For example, as shown in FIG. 34, a composite setting CS regarding a combination of “sheet insert” and “2-in-1” may be specified in the e-mail ML1. To be specific, a character string “sheet insert, 2-in-1, preview” may be written in the subject line of the e-mail ML1. Here, “sheet insert” refers to a print setting for inserting a different sheet and prohibits a combined use with the print setting “2-in-1.” In this case, it is sufficient to determine two composite setting ST21 (“sheet insert” only) and ST22 (“2-in-1”only) as alternatives.

As another example, a composite setting CS regarding a combination of “overlay” and “stamp” may be specified in the e-mail ML1. To be specific, a character string “overlay, stamp, preview” may be written in the subject line of the e-mail ML1. Here, “overlay” refers to a print setting for superimposing an arbitrary image designated by a user on an image to be printed and printing out the resultant image, and “stamp” refers to a print setting for superimposing a stamp image (e.g., “for internal use only”) prepared in advance on the MFP 10 side on an image to be printed and printing out the resultant image. The combination of “overlay” and “stamp” also corresponds to a prohibited combination setting. In this case, it is sufficient to determine two composite settings ST31 (“overlay” only) and ST32 (“stamp” only) as alternatives.

### Modified Example of System

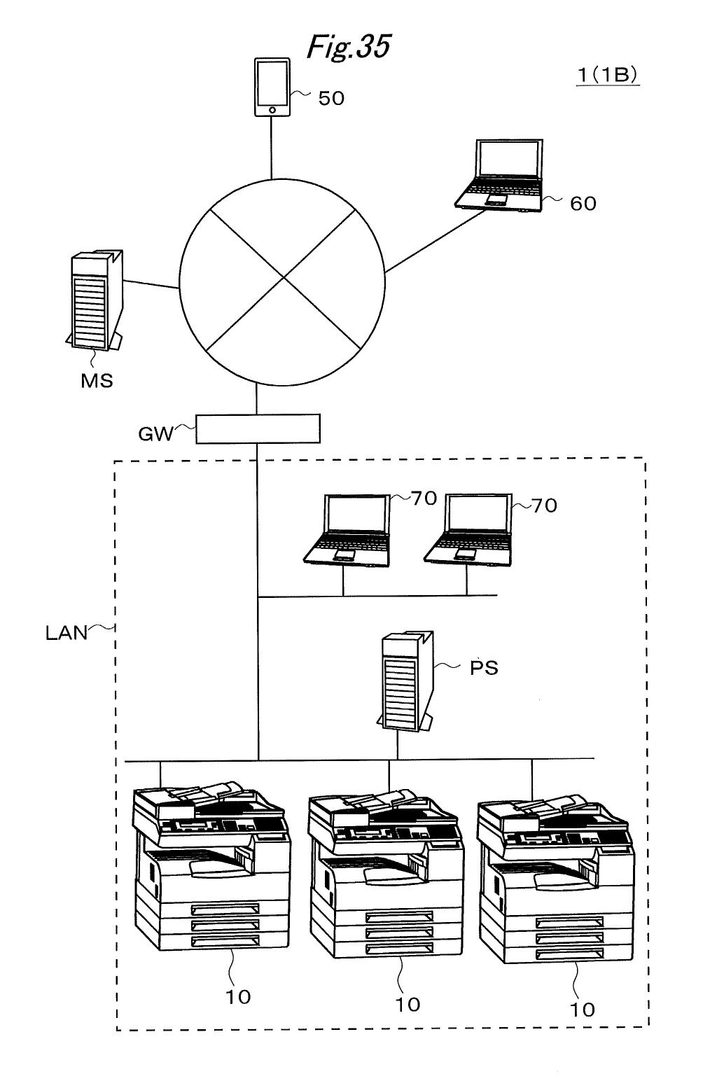

Although the above embodiments describe a mode in which the MFP 10 has both of the printout function and the aforementioned print control function, the present invention is not limited to this. For example, an apparatus having the printout function and an apparatus having the aforementioned print control function may be provided separately. FIG. 35 shows such a modified example.

A printing system 1 (1B) in FIG. 35 further includes a server (e.g., a print server) PS. This server PS is provided in the same LAN as a plurality of MFPs 10 and provided as a print control apparatus for controlling printout operations and print preview operations performed by the plurality of (or one) MFP(s) 10. It is sufficient for the server PS to perform the same operations as the above-described MFP 10 (excluding the printout operation in step S37 (e.g., FIG. 4)). The printout operation in step S37 may be performed by the MFPs 10 under the control of the server PS.

### Other Variations

The above embodiments describe a mode in which each printout image PM is deleted from the storage unit 5 in response to completion of the printout of the printout image PM. The present invention is, however, not limited to this, and each printout image PM may be deleted at other times. For example, each printout image PM may be deleted from the storage unit 5 after a predetermined period of time (e.g., one hour) has elapsed since the printout image PM is stored. In other words, printout images PM that have been stored for a time longer than a predetermined value may be deleted at any time from the storage unit 5.

Although the idea of the present invention is applied to the mobile terminal 50 (more specifically, the operation of exchanging the preview images PV between the mobile terminal 50 and the MFP 10) in the above-described embodiments, the present invention is not limited to this. For example, the idea of the present invention may be applied to the personal computer 60 (more specifically, the operation of exchanging the preview images PV between the personal computer 60 and the MFP 10).

Although the above embodiments describe a mode in which the idea of the present invention is applied to the mobile terminal 50 or the like that is connected only to the network outside the LAN (the network to which the MFP 10 belongs), the present invention is not limited to this. For example, the idea of the present invention may be applied to the personal computers 70 connected in the LAN (the network to which the MFP 10 belongs). In other words, the personal computers 70 may be configured to perform the same operations as the mobile terminal 50.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all variations or changes that come within the meaning and range of equivalency of the claims are intended to be embraced therein.

What is claimed is:

1. A print control apparatus comprising:
a receiving unit configured to receive a first e-mail that includes a print preview instruction, from an external terminal;
an analysis unit configured to analyze the first e-mail and detect the print preview instruction from the first e-mail;
a generation unit configured to generate a preview image on the basis of the print preview instruction; and
a sending unit configured to attach the preview image to a second e-mail and send the second e-mail toward the external terminal.

2. The print control apparatus according to claim 1, wherein
the analysis unit is configured to analyze a content written in a subject line or body of the first e-mail and detect the print preview instruction.

3. The print control apparatus according to claim 1, wherein
the analysis unit is configured to analyze the first e-mail and detect print setting information written in the first e-mail, and
the generation unit is configured to generate the preview image on the basis of the print setting information.

4. The print control apparatus according to claim 3, wherein
the analysis unit is configured to analyze a content written in a subject line or body of the first e-mail and detect the print setting information.

5. The print control apparatus according to claim 1, further comprising:
a storage unit configured to store a printout image corresponding to the preview image; and
a printout control unit configured to control an operation of printing out the printout image,
wherein the generation unit is configured to generate the printout image when generating the preview image and store the printout image in the storage unit,
the receiving unit is configured to receive a third e-mail from the external terminal, the third instruction including a printout instruction to print out the printout image corresponding to the preview image,
the analysis unit is configured to analyze a content written in the third e-mail and detect the printout instruction, and
the printout control unit is configured to print out the printout image in accordance with the printout instruction.

6. The print control apparatus according to claim 5, wherein
the analysis unit is configured to analyze a content written in a subject line or body of the third e-mail and detect the printout instruction.

7. The print control apparatus according to claim 5, wherein
the sending unit is configured to send, toward the external terminal, the second e-mail in which an identifier of the printout image corresponding to the preview image is written,
the receiving unit is configured to receive the third e-mail in which the identifier is written,
the analysis unit is configured to use the identifier written in the third e-mail to specify the printout image corresponding to the preview image, and
the printout control unit is configured to print out the printout image specified by the analysis unit.

8. The print control apparatus according to claim 7, wherein
the analysis unit is configured to use the identifier written in the subject line of the third e-mail to specify the printout image corresponding to the preview image.

9. The print control apparatus according to claim 7, wherein
the analysis unit is configured to use the identifier written in the body of the third e-mail to specify the printout image corresponding to the preview image.

10. The print control apparatus according to claim 7, wherein
the analysis unit is configured to use the identifier included in a filename of an attached file in the third e-mail to specify the printout image corresponding to the preview image.

11. The print control apparatus according to claim 5, wherein
the receiving unit is configured to receive the third e-mail with the preview image attached,
the analysis unit is configured to use the preview image attached to the third e-mail to specify the printout image corresponding to the preview image, and
the printout control unit is configured to print out the printout image specified by the analysis unit.

12. The print control apparatus according to claim 11, wherein
the analysis unit is configured to perform pattern matching processing using the preview image attached to the third e-mail to specify the printout image corresponding to the preview image.

13. The print control apparatus according to claim 5, wherein
the printout control unit is configured to delete the printout image from the storage unit upon completion of printout of the printout image.

14. The print control apparatus according to claim 5, wherein
the printout control unit is configured to delete the printout image from the storage unit after a predetermined period of time elapses since the printout image is stored.

15. The print control apparatus according to claim 3, wherein
the print setting information written in the first e-mail includes setting information regarding a combination of a plurality of print settings,
the generation unit is configured to generate the preview image in accordance with a composite setting that is a combination of the plurality of print settings, and
the sending unit is configured to attach the preview image to the second e-mail and send the second e-mail toward the external terminal.

16. The print control apparatus according to claim 15, wherein
the analysis unit is configured to determine whether or not the composite setting specified in the print setting information is a prohibited combination setting,
the generation unit is configured to generate the preview image in accordance with the composite setting when it is determined that the composite setting is not a prohibited combination setting, and
the sending unit is configured to attach the preview image to the second e-mail and send the second e-mail toward the external terminal.

17. The print control apparatus according to claim 15, wherein
the analysis unit is configured to determine whether or not the composite setting specified in the print setting information is a prohibited combination setting, and
the sending unit is configured to, when it is determined that the composite setting is the prohibited combination setting, write a message indicating that the composite setting is the prohibited combination setting in the second e-mail and send the second e-mail toward the external terminal.

18. The print control apparatus according to claim 3, wherein
the print setting information written in the first e-mail includes setting information regarding a combination of a plurality of print settings,
the analysis unit is configured to determine whether or not a composite setting that is a combination of the plurality of print settings that is specified in the print setting information is a prohibited combination setting, and when it is determined that the composite setting is a prohibited combination setting, determine at least two composite settings that are available among a plurality of composite settings, each consisting of at least one of the plurality of print settings, as alternatives.
the generation unit is configured to generate a plurality of preview images in accordance with the at least two composite settings serving as the alternatives, and
the sending unit is configured to attach the plurality of preview images to at least one second e-mail and send the at least one second e-mail toward the external terminal.

19. The print control apparatus according to claim 18 wherein
the at least one second e-mail includes a single second e-mail, and
the single second e-mail has attached thereto image data generated by consolidating the plurality of preview images.

20. The print control apparatus according to claim 18, wherein
the at least one second e-mail includes a plurality of second e-mails, and
the plurality of second e-mails have respectively attached thereto the plurality of preview images.

21. The print control apparatus according to claim 18, wherein
the at least one second e-mail includes a single second e-mail, and
the single second e-mail has attached thereto the plurality of preview images.

22. The print control apparatus according to claim 18, further comprising:
a storage unit configured to store a plurality of printout images corresponding to the plurality of preview images; and
a printout control unit configured to control an operation of printing out the plurality of printout images,
wherein the generation unit is configured to generate the plurality of printout images when generating the plurality of preview images and store the plurality of printout images in the storage unit,
the receiving unit is configured to receive, from the external terminal, a third e-mail that includes a printout instruction to print out one of the plurality of preview images,
the analysis unit is configured to analyze a content written in the third e-mail and detect the printout instruction, and
the printout control unit is configured to print out a printout image that corresponds to one of the plurality of preview images in accordance with the printout instruction.

23. The print control apparatus according to claim 22, wherein
the analysis unit is configured to use a specific preview image attached to the third e-mail among the plurality of preview images to specify a single printout image to be printed, and
the printout control unit is configured to print out the single printout image specified by the analysis unit.

24. The print control apparatus according to claim 22, wherein
the analysis unit is configured to specify a single printout image to be printed from among the plurality of printout images corresponding to the plurality of preview images, on the basis of a content written in a subject line or body of the third e-mail, and
the printout control unit is configured to print out the single printout image specified by the analysis unit.

25. The print control apparatus according to claim 22, wherein
the at least one second e-mail includes a single second e-mail,
the single second e-mail has attached thereto the plurality of preview images,
the single second e-mail includes data for displaying a plurality of selection buttons for selecting a desired composite setting from among the at least two composite settings, and
the receiving unit is configured to receive the third e-mail that is generated in response to pressing of one of the plurality of selection buttons displayed in a window displaying the single second e-mail and that includes a printout instruction to print out one printout image corresponding to the one of the plurality of selection buttons.

26. The print control apparatus according to claim 25, wherein
the third e-mail is automatically generated by the external terminal and is automatically sent from the external terminal to the print control apparatus, in response to pressing of one of the plurality of selection buttons displayed in the window displaying the single second e-mail.

27. A non-transitory computer-readable recording medium storing a program for causing a computer serving as a print control apparatus to execute:
a) receiving a first e-mail that includes a print preview instruction from an external terminal;
b) analyzing the first e-mail and detecting the print preview instruction from the first e-mail;
c) generating a preview image on the basis of the print preview instruction; and
d) attaching the preview image to a second e-mail and sending the second e-mail toward the external terminal.

28. A printing system comprising;
a printout apparatus that includes a print control apparatus; and
an external terminal,
the printout apparatus including:
a receiving unit configured to receive a first e-mail that includes a print preview instruction, from the external terminal;
an analysis unit configured to analyze the first e-mail and detect the print preview instruction from the first e-mail;
a generation unit configured to generate a preview image on the basis of the print preview instruction; and
a sending unit configured to attach the preview image to a second e-mail and send the second e-mail toward the external terminal.

29. A printing system comprising:
a printout apparatus;
a print control apparatus; and
an external terminal,
the print control apparatus including:
a receiving unit configured to receive a first e-mail that includes a print preview instruction, from the external terminal;
an analysis unit configured to analyze the first e-mail and detect the print preview instruction from the first e-mail;
a generation unit configured to generate a preview image on the basis of the print preview instruction; and
a sending unit configured to attach the preview image to a second e-mail and send the second e-mail toward the external terminal.
